(19) United States
(12) Patent Application Publication
(10) Pub. No.: US 2012/0253943 A1
(43) Pub. Date: Oct. 4, 2012

(54) METHOD AND SYSTEM FOR ADVERTISING INFORMATION ITEMS

(76) Inventor: Edmond K. Chow, Hong Kong (HK)

(21) Appl. No.: 13/436,326

(22) Filed: Mar. 30, 2012

Related U.S. Application Data
(60) Provisional application No. 61/469,800, filed on Mar. 30, 2011.
(60) Provisional application No. 61/486,242, filed on May 14, 2011.

(51) Int. Cl. G06Q 30/02

(52) U.S. Cl. 705/14.69

(57) ABSTRACT

An invention is disclosed for an advertising system, method, or process that enables sellers to efficiently associate their advertisements with specific content, and presents these ads to consumers whose attention of interest corresponds to the content. Such a system, method, or process also provides a more reliable, accurate, or otherwise effective way of presenting relevant ads to consumers and affording sellers an effective advertising campaign.

### CROSS REFERENCE TO RELATED APPLICATIONS

This application claims benefit under 35 U.S.C. §119(e) of provisional U.S. patent application No. 61/469,800, filed Mar. 30, 2011, and of provisional U.S. patent application No. 61/486,242, filed May 14, 2011, the contents of all of which are incorporated herein by reference in their entirety.

### TECHNICAL FIELD

This invention relates to methods and systems for advertising and, in particular, to methods and systems for advertising information items.

### BACKGROUND

To market or advertise a particular entity of commercial, professional, or public interest, such as a product, service, seller, brand, offer, event, website, charity, URL (Uniform Resource Locator), and so on, information items such as textual, audio, visual, multi-media, or interactive notices or ads are often placed alongside with, or in-between, some other contents, so to attract public attention or patronage for that particular entity. Examples of such information items include radio announcements, electronic billboards, banner ads, and sponsored URLs. In an interactive digital environment such as the World Wide Web (i.e., the Web), consumers have control to select some information items over other information items for consumption and can change their interests or selections anytime. While it is believed that the most effective ads are those deemed relevant to the interest of their target audience at any moment, it has been difficult to reliably present ads that sellers or advertisers deem relevant to the consumers based on their changing interests.

It is equally difficult, if not more so, for the sellers or advertisers to identify specific information items in a vast online repository of information items (such as those digital resources available on the Web or through a search engine), and have their ads presented in connection with these information items when a user has shown interest in one of these information items. For example, a seller may associate his ad with keywords provided by a search service, so that when a user sends the search service a query comprising those keywords, the search service would present the user with the ad along with the search results. There are many problems with current online advertising, some of which are well-known.

### SUMMARY

One problem with current online advertising is that keywords in such a query do not provide enough information to identify the information items of interest of a user, and the seller often does not want its ads to be associated or presented along with search results that merely contain matching keywords and no relevant content of interest.

The present invention addresses these difficulties, and provides other benefits.

In accordance with one aspect of the invention, there is provided a method for advertising a set of information items based at least in part on another set of information items. The method involves receiving a submission or selection of a set of information items, identifying another set of information items based at least in part on user input, receiving a selection of an information item, determining if the selected information item matches the other set of information items, and presenting a response based at least in part on the set of information items if the selected information item matches the other set of information items, wherein the response includes one or more information items in the set of information items, or a reference or means of access to one or more information items in the set of information items. Examples of criteria on whether the selected information item is deemed matching the other set of information items include that the other set of information items comprises or refers to the selected information item or part thereof, that the selected information item comprises or refers to at least one information item in the other set of information items, and that an information item in the other set of information items and the selected information item comprise or refer to the same information item, or an equivalent or comparable information item. The method may further involve inserting at least one information item in the set of information items into the selected information item or place the at least one information item between parts of the selected information items.

In accordance with another aspect of the invention, there is provided a method for advertising an offer. The method involves receiving a submission or selection of an offer entry, identifying information parts in the offer entry, receiving a selection of an information item, the information item including another offer entry, a webpage, an article, a sound track, an image, or video, determining if the selected information item comprises or refers to at least one of the information parts, and presenting the offer entry or otherwise making it a candidate offer entry for advertising if the selected information item comprises or refers to at least one of the information parts.

In accordance with another aspect of the invention, there is provided a method for prioritizing a plurality of sets of candidate information items for advertising in a response having a limited number of positions. The method involves selecting an unassigned position in the response, the unassigned position associated with the highest advertising charge among all available positions; determining the highest cost limit associated with the plurality of sets of candidate information items, each of the sets of candidate information items including an information item not assigned to any position in the response and having target position criteria met by the unassigned position, and a remaining balance sufficient for the highest cost limit or charge, whichever is lower; selecting a set of candidate information items from the plurality of sets of candidate information items based at least in part on some specific criteria including round robin, highest remaining balance first, highest budget first, and so on; assigning an information item in the set of candidate information items to the unassigned row position, the information item not yet assigned to any position in the response; deducting from the remaining balance associated with the set of candidate information items an amount equal to the highest cost limit, or the highest charge associated with the unassigned row position, whichever is lower; and repeating from the above step of selecting an unassigned position in the response associated with the highest charge, until there is no more unassigned position in the response, or no more candidate information item that is not assigned to any position in the response and has target position criteria met by the unassigned position.

In accordance with another aspect of the invention, there is provided a method for determining a set of popular information items. The method involves associating information items in a database each with a popularity score; receiving a request to associate an information item with another information item; increasing the popularity score associated with the other information item; and determining a set of popular information items among the information items, each in the set of popular information items having a higher popularity score than information items not in the set of popular information items. The method may further involve presenting at least one popular information item in the set of popular information items. Each of the at least one popular information item may be associated with one or more advertising costs. The method may then further involve adjusting the one or more advertising costs associated with each of the at least one popular information item based at least in part on the popularity score associated with each of the at least one popular information item.

In accordance with another aspect of the invention, there is provided a method for advertising an information item, the method including presenting a set of information items to a first user, the first user being associated with an account, and the set of information items including one or more information items and being relative to a subject matter, wherein the one or more information items are each associated with cost information; receiving from the first user an indication of a first information item, the first information item being relative to the set of information items; receiving an indication of a second information item, the second information item being associated with the account; associating the first information item with the second information item; determining rate information relative to the cost information; presenting another set of information items to a second user; detecting an indication of a third information item, the third information item being relative to the other set of information items; determining that the third information item matches the first information item; presenting a response to the second user, the response being based at least in part on a representation or indication of the second information item, or part thereof; determining a charge relative to the rate information; and applying the charge in association with the account. In accordance with yet another aspect of the invention, there is provided a method for promoting an advertisement or ad, the method including presenting a first set of information items that may be associated with an advertisement to a first user, the first user being associated with an account, the set of information items comprising a first information item, the first information item being related a subject matter and having a cost information; receiving from the first user an indication of selecting the first information item; in relation to receiving the indication of selecting the first information item, receiving an indication of a second information item from the first user, the second information item being associated with the account, the second information item comprising an advertisement to be associated with the first information item; in response to receiving the indication of the second information item, and to receiving the indication of selecting the first information item, associating the first information item with the second information item; determining a rate information for presenting the second information item with the first information item based on the first information item's cost information; presenting a second set of information items to a second user, the second set of information items comprising a third information item, the second set of information items comprising content requested by the second user; receiving an indication of selecting the third information item for the second user; in response to determining that the third information item matches the first information item, and to associating the first information item with the second information item, presenting a response to the second user, the response comprising a representation or indication of at least a part of the second information item; determining a charge for presenting the response based on the rate information; and applying the charge to the first user's account.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

FIG. 1 illustrates an example environment for advertising information items on behalf of a user to another user.

FIG. 2 illustrates a block diagram of an example information retrieval system.

FIG. 3 illustrates a block diagram of an example promotion engine.

FIG. 4 illustrates a block diagram of a processor system implementing an information retrieval system comprising a promotion engine.

FIG. 5 illustrates an example presentation or screenshot that may appear on a device coupled to a user, such as the device coupled to the supplying user shown in FIG. 1.

FIG. 6 illustrates a flow diagram of an example process for advertising information items.

FIG. 7 illustrates a flow diagram of an example process for advertising offer information entries.

FIG. 8 illustrates an example presentation or screenshot that an information retrieval system equipped with the present invention may present to a user through a device to which she is coupled.

FIG. 9 illustrates a flow diagram of an example process for selecting information items from a plurality of sets of candidate information items, and prioritizing them in a response to a user.

FIG. 10 illustrates a flow diagram of an example process for determining the popularity of an information item.

FIG. 11 illustrates a flow diagram of an example process for advertising a set of information items based at least in part on another set of information items.

### DETAILED DESCRIPTION OF ILLUSTRATIVE EMBODIMENTS

A method and system for advertising information items to a user on behalf of another user is provided. A user (an information item-supplying user, or simply a supplying user) may relate a set of information items to another set of information items, so that when the set of information items may become a candidate for presentation to another user (an information item-consuming user, or simply a consuming user) when the other user indicates interest in any member in the other set of information items. Supplying users may also specify criteria that target their information items to consuming users with specific attributes or in specific locations.

There may be cases where the number of candidate information items available is more than what may be presented to a consuming user in a given response, session or setup. According to one embodiment, candidate information items associated with a higher priority may be selected over those with a lesser priority. For example, levels of priorities may be established by how much supplying users are willing to pay for presentation of their information items (i.e., as advertisements or ads) to consuming users, a higher limit amounting to a higher priority. According to another embodiment, round robin or random selection may also be employed in connection with other selection policies or schemes. According to yet another embodiment, popular information items may readily be made known to supplying users so that they may associate their ads with these popular information items for increased exposure or relevance. As supplying users identify information items for association with their information items or ads so to promote the latter, the former will have their individual popularity scores increased, in addition to contributions from other popularity evaluation policies or schemes that may also be employed. This “supply-side” activity will further help discover popular information items for the benefits of both the supplying user and the consuming user. In embodiments, any unit of digital content or resource may be regarded as an information item. A reference or means of access to such digital contents or resources may also be regarded as an information item. For example, a webpage, video, or a blog available on the Web is an information item, so is a URL, hyperlinked image, or on-screen button to that webpage, video, or blog.

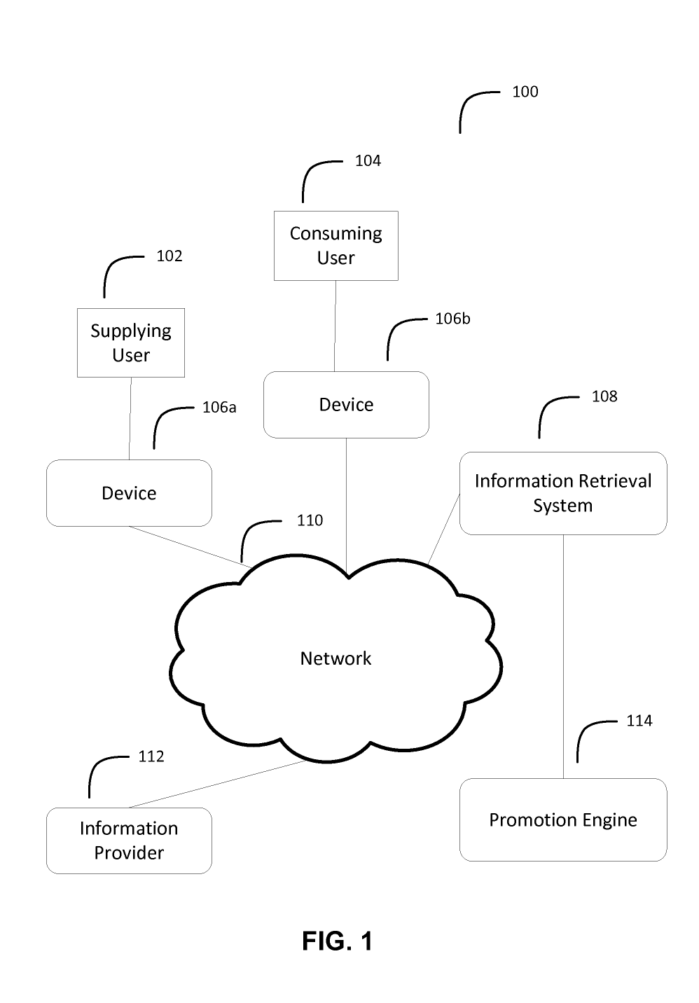

FIG. 1 illustrates an example environment 100 for advertising information items on behalf of a user to another user. A plurality of users, such as the supplying user 102 and the consuming user 104 at their respectively devices 106a and 106b, are communicatively coupled to an information retrieval system 108 via a network 110. (In embodiments, any type of network is within the scope of various embodiments.) The information retrieval system 108 may comprise an entity that provides information retrieval services, content publication services, advertising services, news services, internal or external corporate information services, and so on. For example, the information retrieval system 108 may provide a search engine that accepts queries or requests from one or more users through a device such as a computer, a terminal, or mobile phone, and provides one or more information items for presentation to the one or more users. The mode of such queries, requests or presentations may be textual, visual, audio, tactile, or anything communicable to or perceivable by the users. In addition, the information retrieval system 108 may act as a gateway or proxy to information items available at another information provider 112, to which the system may be coupled via a network. Examples of the other information provider 112 include but are not limited to a search engine, a shopping website, a news portal, an online video download or streaming site, or the Web. For example, the information retrieval system 108 may present URLs to information items that reside on another website or server.

A promotion engine 114 is communicatively coupled to the information retrieval system 108. The promotion engine 114 maintains relationships between the supplying user 102 (or the account of which the supplying user 102 represents) and the information items (i.e., ads) that the user intends to advertise, and between these ads and third-party information items. The promotion engine 114 also selects the appropriate ads for presentation to the consuming user 104 based at least in part on their indications of interests regarding these third-party information items.

For instance, according to one embodiment, the supplying user 102 may send via the device 106b a query for information items on retail items, brand, sellers, and offers to a search engine (not shown) comprised by or otherwise associated with the information retrieval system 108. The supplying user 102 may then associate his ads (i.e., information items that the supplying user intends to advertise) with a subset of the information items returned by the information retrieval system 108 in response to the query. The promotion engine 114 would handle such association requests and maintain these association relationships. A consuming user may via another device indicate to the information retrieval system 108 his interest in one of the information items in the subset. For example, the consuming user may click on or otherwise select a URL, hyperlinked text (i.e., hypertext), or hyperlinked image corresponding to that information item in a webpage or a list of search results as may be provided by the search engine or the information retrieval system 108. The promotion engine 114 would select or otherwise identify one or more of these ads in response to this user selection. The information retrieval system 108 would make available the one or more ads so selected or identified for presentation or indication to the consuming user 104 along with the information item that the consuming user 104 has expressly indicated interest in. A supplying user may also be a consuming user, and vice versa. And a supplying user may represent an organization or corporation, or may be a machine or computer system acting in the role of a supplying user. And one or more supplying or consuming users may be communicatively coupled to the information retrieval system 108 directly without via a network. According to other embodiments, the information retrieval system 108 may comprise the promotion engine 114, or the promotion engine 114 may comprise a module or component associated with the information retrieval system 108.

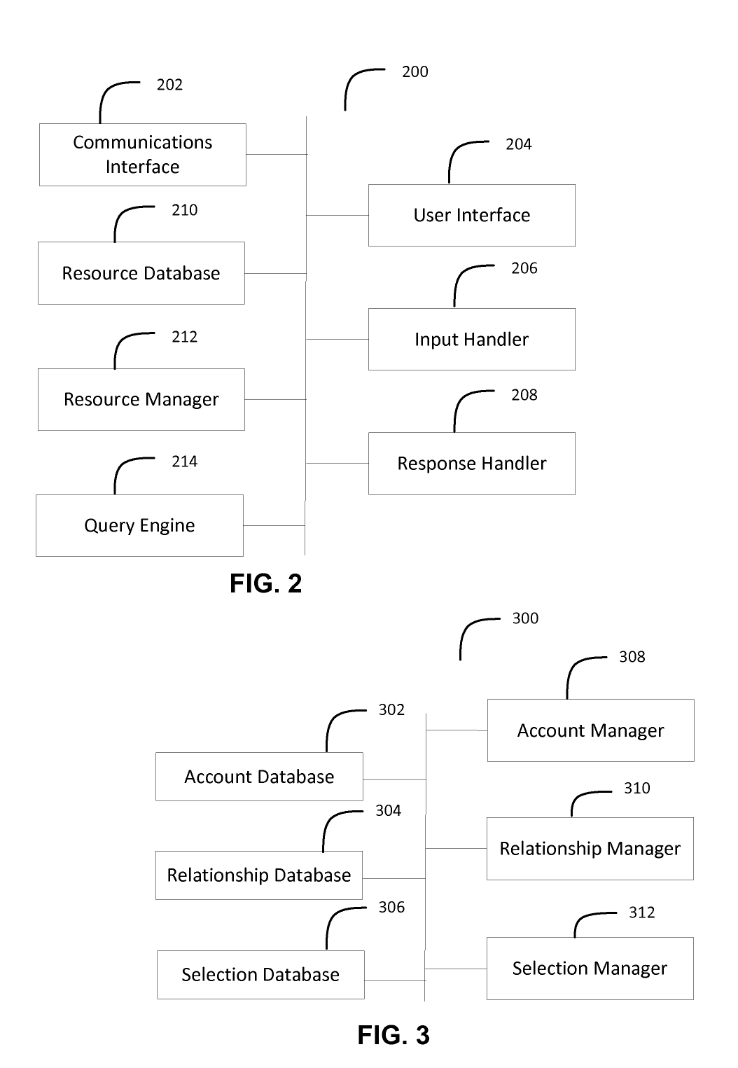

Referring to FIG. 2, a block diagram of an example information retrieval system 200, such as the information retrieval system 108 illustrated in FIG. 1, is shown. The example information retrieval system 200 includes a communications interface 202, a user interface 204, an input handler 206, a response handler 208, a resource database 210, a resource manager 212, and a query engine 214.

The communications interface 202 is provided for communicating with devices over a communications medium, such as the device 106a or 106b and the network 110 shown in FIG. 1. These devices communicate with the information retrieval system 200 via the communications interface 202 utilizing various modes of delivery of data or messages, such as requests, responses, and notifications. Examples of such requests include login credentials, submissions of information items, queries for information items, requests for presentation of information items, and so on. Examples of such responses include search results or parts thereof, an information item or parts thereof, references to information items, error messages, and so on. Examples of such notifications include asynchronously generated information items, alerts of information items, location-triggered or time-of-day messages, and so on. Any type of communications interface or mode of delivery is within the scope of various embodiments.

The user interface 204 is provided for communicating with a user, such as via the devices 106a and 106b described herein. It is configured to interact with the user to obtain his input and present output to him. For instance, it may be configured to communicate with a display engine or graphical user interface included in the devices 106a and 106b that are coupled to the user. It may also comprise a display engine or graphical user interface capable of accepting and presenting information from and to the user, whether the information is graphical, textual, audio, or any other mode of communication. For example, the user interface 204 may present a search input box with which the user types in their query, accept the query, and present information items in response to the query. Data or messages between the user and the user interface 204 are delivered via the communications interface 202. Any type of user interface is within the scope of various embodiments.

The input handler 206 is provided for processing requests and collecting information items. For instance, it interprets requests received by the user interface 204 from the user or the device to which he is coupled, and directs or otherwise causes other components or modules in the information retrieval system 200 to fulfill those requests. Examples of such requests include a query, an information item submission, account login, and so on. For example, the input handler 206 may cause the resource manager 212 to store information items in the resource database 210 in relation to an information item submission request. For a query request, the input handler 206 may cause the query engine 214 and response handler 208 to process the query and respond to the user or the device via the user interface 204. According to one embodiment, the input handler 206 may for some requests respond to the device or the user via the communications interface 202 or user interface 204. Examples of this type of requests include an information submission request, new user account request, information item association request, and so on. The input handler 206 may also generate inter-component or inter-module instructions based on or in response to incoming requests or information items. In some embodiments, the input handler 206 includes a proxy for gathering or collecting information items from an information source, such as the information provider 112 shown in FIG. 1. An example of such a proxy includes a crawler collecting resources from the Web.

The response handler 208 is provided for preparing data for delivery to the device via the communications interface 202 and for presentation to the user via the user interface 204. For instance, it may cause the query engine 214 to retrieve relevant information items when it receives instructions from the input handler 206 to process a query for information items. After receiving the results from the query engine 214, the response handler 208 may select the most relevant set of results and present to the user via the user interface 204 a response comprising this set of results. It may also include as part of the response a reference such as a URL with which the user may obtain another set of the results via the user interface 204. In some embodiments, the user interface 204 may cause the response handler 208 to process this request for the other set of results without involving the input handler 206. The response handler 208 then causes the query engine 214 to retrieve the other set of results. According to other embodiments, the user interface 204 may cause the resource manager 212 to retrieve the other set of results. The response handler 208 may also interact with a promotion engine such as the promotion engine 114 shown in FIG. 1 to retrieve additional information items or references to additional information items and make them available as part of the response for delivery and presentation to the device and the user.

The resource database 210 is provided for storing information items and their related data, including but not limited to their submission and publication timestamps, authorship, submitter identification, authorship or submitter privacy settings, and so on. The information items and their related data may be stored, modified, added and so forth to any storage medium. Examples of timestamp include order of occurrence in a database, date, time of day, and the like. According to one embodiment, the resource database 210 includes at least one index for the information items available therein.

The resource manager 212 is provided for maintaining, organizing and operating the resource database 210. Other modules or components communicate with the resource manager 212 for access to the resource database 210. In one embodiment, other modules or components such as the query engine 214 may access the resource database 210 directly to search information items or their corresponding indexes. In some embodiments, the resource manager 212 includes an indexing component or module that indexes the information items available in the resource database 210 and facilitate fast information retrieval for the information items. It maintains and stores such indexes in the resource database 210.

The query engine 214 is provided for handling queries for information items and related data or metadata. It interprets or validates the queries and provides results to the queries as well as other data pertaining to the queries or results. For example, the query engine 214 may include in its response the size of the available results and the searching time associated with a query. It communicates with the resource manager 212 for access to the resource database 210 where the information items and their related data or metadata are stored. In some embodiments, the query engine 214 may access the resource database 210 without involving the resource manager 212 as an intermediary.

Although the information retrieval system 200 is described as comprising various components or modules (the communications interface 202, the user interface 204, the input handler 206, the response handler 208, the resource database 210, the resource manager 212, and the query engine 214), fewer or more components or modules may be included in the information retrieval system 200 and still fall within the scope of various embodiments. For example, the resource manager 212 may comprise the query engine 214. The input handler 206 may further be divided into two components or modules, one for handling user requests and the other for handling information items from an external information provider. The input handler 206 may comprise the response handler 208, the response handler 208 may comprise the query engine 214 and resource manager 212, or the user interface 204 may comprise both the input handler 206 and response handler 208. And so on.

A promotion engine such as the promotion engine 114 shown in FIG. 1 may be configured to maintain user accounts associated with supplying users, handle requests or instructions for relating or associating a set of information items to or with another set of information items, establish and maintain such relationships and associations, and promote one or more information items in the set of information items based at least in part on input from the input handler 206, the response handler 208, or some other component or module. For example, the promotion engine 114 may receive a new user account request from the input handler 206, and create a new user account in response to the request. It may receive an item information association request from the input handler 206, and create and maintain the association or relationship between an information item and another information item in response to the request. It may receive from the response handler 206 data about an information item selected by the consuming user 104, and select one or more information items available in the information retrieval system 108 in response to the data or based at least in part on the selected information item. In one embodiment, the promotion engine 114 may receive the information item of user interest and identify other information items available in or otherwise referred to by the information item, and select for advertising one or more information items available in the information retrieval system 108 based at least in part on these other information items. It may also select information items based on a part, segment, or section of the information item of user interest, and make them available as ads in relation to the part, segment, or section of the information item.

Referring to FIG. 3, a block diagram of an example promotion engine 300, such as the promotion engine 114 shown in FIG. 1, is shown. The example promotion engine 300 includes an account database 302, relationship database 304, selection database 306, account manager 308, relationship manager 310, and selection manager 312.

The account database 302 is provided for storing data associated with a user account, such as an account for the supplying user 102 shown in FIG. 1. For instance, when a user subscribes to advertising or other services provided by the information retrieval system 108, an account may be generated for the user. For example, the supplying user 102 may provide logon credentials, budget information and other settings such as a daily cost limit, a maximum charge limit per thousand impressions, and so on. When the supplying user 102 adds or modifies information to or in the account, such as changing the amount of his overall budget or adding an expiry to an ad campaign, the account in the account database 302 may be updated with the information added or modified. The account may be stored, modified, added and so forth to any storage medium. A timestamp may be associated with the account. Examples of timestamp include order of occurrence in a database, date, time of day, and the like. In some embodiments, the account or part of the account may be created outside of the promotion engine 114 or outside the information retrieval environment 100. For example, a third-party email or membership account may be used as logon credential for the user account. Alternatively, the account database 302 may be located externally or remotely and accessed by the information retrieval system 108 or promotion engine 114 over the network 110 or another network.

The account manager 308 is provided for maintaining, organizing and operating the account database 302. Other modules or components communicate with the account manager 308 for access to the account database 302, such as initiating a search of the account database 302. In one embodiment, the selection manager 312 may access the account database 302 directly to search account information. In some embodiments, the account manager 308 includes an indexing component or module that indexes the data available in the account database 302 and facilitate fast information retrieval for the data. It maintains and stores such indexes in the account database 302. In some embodiments, the account manager 308 is operably configured to cause the query engine 214 to search the account database 302.

The relationship database 304 is provided for storing data pertaining to relationships and associations relative to information items, such as the information items available in the information retrieval system 108 and the information provider 112 shown in FIG. 1. Example relationship and association data include associations between a user account and a plurality of sets of information items, associations between a budget available in a user account and a set of information items, associations between information items as ad and other information items that trigger or implicate them, relationships between information items as content, section, part or segment and their referring or embedding information items, an information item relating one information item to another, and so on. The data in the relationship database 304 may be stored, modified, added and so forth to any storage medium. A timestamp may be associated with the account. In some embodiments, the relationship and association data or parts of the data may be created outside of the promotion engine 114 or outside the information retrieval environment 100. For example, a third-party social network may provide relationships between information items and user accounts. Alternatively, the relationship database 304 may be located remotely and accessed by the information retrieval system 108 or promotion engine 114.

The relationship manager 310 is provided for maintaining, organizing and operating the relationship database 304, or any other database where relationship or association information among entities such as information items is available and obtainable. For example, two different information items may be related by a common part or constituent information item, such as two offer information items having or referring to the same brand despite having or referring to different product names and sellers. Other modules or components communicate with the relationship manager 310 for access to the relationship database 304, such as initiating a search of the relationship database 304. In one embodiment, other components or modules such as the selection manager 312 may access the relationship database 304 directly to search information on relationships and associations. In some embodiments, the relationship manager 310 includes an indexing component or module that indexes the data available in the relationship database 304 and facilitate fast information retrieval for the data. It maintains and stores such indexes in the relationship database 304. In some embodiments, the relationship manager 310 is operably configured to cause the query engine 214 to search the relationship database 304.

The selection database 306 is provided for storing data associated with selections of information items for advertising on behalf of supplying users, such as the supplying user 102 shown in FIG. 1. Example selection-related data include impression counts, impression timestamps, assigned priorities or positions, and so on, for information items that have been selected for presentation as ad to consuming users. The data in the selection database 306 may be stored, modified, added and so forth to any storage medium. A timestamp may be associated with data entries in the selection database 306. In some embodiments, the data or part of the data may be created outside of the promotion engine 114 or outside the information retrieval environment 100. For example, a third-party billing or accounting system may provide the storage and maintenance of the selection-related data. Alternatively, the selection database 306 may be located remotely and accessed by the information retrieval system 108 or promotion engine 114.

The selection manager 312 is provided for selecting information items for advertising. For instance, it selects information items in relation to a given information item based at least in part on relationships or associations between the given information item and other information items available in or through the information retrieval system 108. For example, the selection manager 312 may receive from the response handler 208 an information item selected by the consuming user 104. It causes the relationship manager 310 to search the relationship database 304 for associations between the information item and one or more information items provided by or otherwise associated with the supplying user 102 or any other supplying users (whose accounts are stored in the account database 302). If data for such associations exist, the selection manager 312 causes the resource manager 212 to retrieve the one or more information items from the resource database 210 based at least in part on the data. In one embodiment, the selection manager 312 may choose from the one or more information items a subset of information items whose “last selected” timestamps are the oldest, up to some maximum limit on the size of the subset imposed by the response handler 208. The selection manager 312 updates the “last selected” timestamps and impression counts in the selection database 306 for the chosen information items. It may also check via the account manager 308 if the account balances associated with the chosen information items have sufficient funds to pay for the impressions before finalizing the selections. In another embodiment, the promotion engine 114 may receive the information item of user interest (e.g., an article) and analyze its content to determine if it contains information items (e.g., a seller or brand name) for which there exists in the relationship database 304 one or more associations between these information items and one or more information items in the resource database 210 as provided by or otherwise associated with the supplying user 102 or any other supplying users. In yet another embodiment, the selection manager 312 may select information items for advertising based on a part, segment, or section of the information item of user interest, associate the advertising information items with the part, segment, or section of the information item, and cause the response handler 208 to automatically make available (e.g., via the user interface 204) the advertising information items to the consuming user 104 without any further user input when the information retrieval system 108 presents the part, segment or section of the information item to the consuming user 104 via a coupled device such as the device 106b shown in FIG. 1. In some embodiments, the selection manager 312 is operably configured to cause the query engine 214 to search the selection database 306.

Although the promotion engine 300 is described as comprising various components or modules (the account database 302, the relationship database 304, the selection database 306, the account manager 308, the relationship manager 310, and the selection manager 312), fewer or more components or modules may be included in the promotion engine 300 and still fall within the scope of various embodiments. For example, the resource database 210 and resource manager 212 may comprise the account database 302 and account manager 308 respectively. Or the selection database 306 and selection manager 312 may comprise the account database 302 and account manager 308 respectively. Or the resource database 210 may comprise the selection database 306, and the selection manager 312 is configured to interact with the resource manager 212 to add, update and remove selection-related data therein. Or a single database may comprise the account database 302, relationship database 304, and selection database 306 (as well as the resource database 210). Or a single database manager may be configured to maintain the account database 302, relationship database 304, and selection database 306 (as well as the resource database 210), and provide access to these databases.

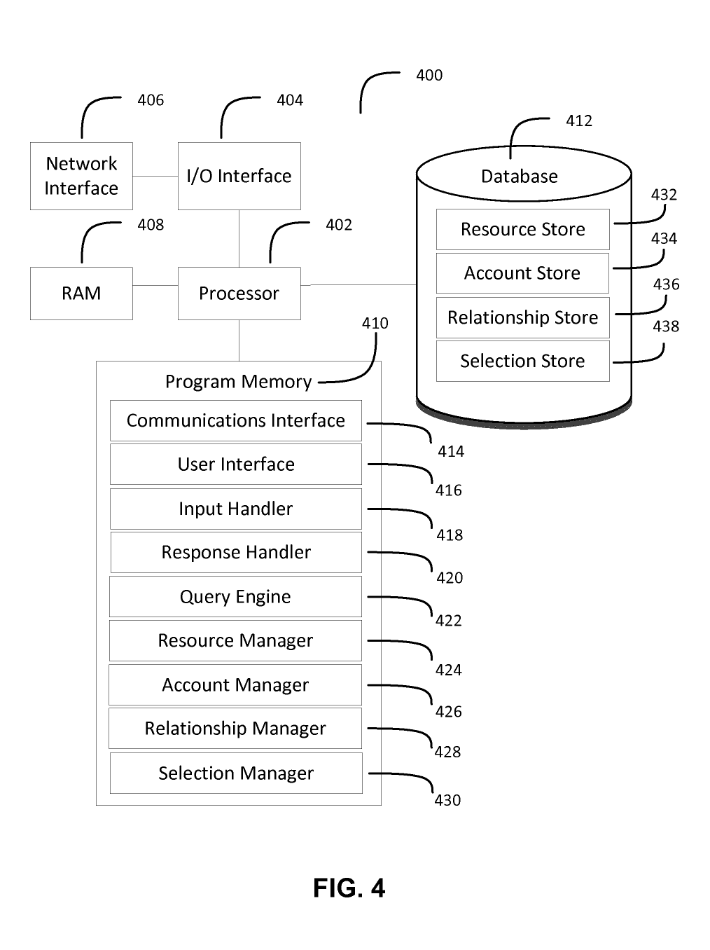

Referring to FIG. 4, a general block diagram of a processor system 400 implementing an information retrieval system comprising a promotion engine, such as the example information retrieval system 300 and the example promotion engine 400 shown in FIG. 2 and FIG. 3 respectively, is shown. Generally, in the embodiment shown, the processor system 400 includes a processor circuit comprising a processor 402, and an input/output (I/O) interface 404 to which a network interface 406 is coupled. The processor is also in communication with random access memory (RAM) 408, program memory 410 and database memory 412. The processor 402 controls the database memory 412 under the direction of a general database manager (not shown), a specialized database manager (not shown), a combination thereof (herein referred to as a hybrid database manager), or a collection of database managers, implemented in codes stored in the program memory 410 that direct the processor 402 to perform database management functions to maintain one or more databases of data records in the database memory 412.

The term “processor system” has been used to indicate that the processor circuit shown in FIG. 4 is only one of a plurality of implementations and configurations and that, for example, the processor system 400 may employ a plurality of processors locally or geographically distributed to effect the functions described below that are performed by the processor system 400. The processor system 400 may be configured to contain fewer or more components. For example, the RAM 410 may comprise storage for parts of or the entire database 412. Or the general database manager, the specialized database manager, the hybrid database manager, or the collection of database managers may include codes that direct the processor 402 to communication with a database located remotely from the information retrieval system so realized. The remotely located database could be a commercial database, for instance, and the information retrieval system may merely be configured to interact with such database without requiring substantial memory or detailed database management functionality at the information retrieval system. A terminal interface (not shown) may be connected to the I/O interface 404 for direct interaction with users. Or the I/O interface 404 may comprise the network interface 406. The processor system 400 may comprise a plurality of distributed processors, program memories, and databases coupled over a network. Or it may comprise a plurality of processor subsystems each capable of operating as a standalone processor system.

To enable an information retrieval system (such as the information retrieval system 108 shown in FIG. 1) to perform the functionality described above in which information items are advertised to a user on behalf of another user, the program memory 410 includes the following components or modules: a communications interface 414 (such as the one (202) shown in FIG. 2, and being operably configured to perform its functionality as described above), a user interface 416 (such as the one (204) shown in FIG. 2, and being operably configured to perform its functionality as described above), an input handler 418 (such as the one (206) shown in FIG. 2, and being operably configured to perform its functionality as described above), a response handler 420 (such as the one (208) shown in FIG. 2, and being operably configured to perform its functionality as described above), a query engine 422 (such as the one (214) shown in FIG. 2, and being operably configured to perform its functionality as described above), a resource manager 424 (such as the one (212) shown in FIG. 2, and being operably configured to perform its functionality as described above), an account manager 426 (such as the one (308) shown in FIG. 3, and being operably configured to perform its functionality as described above), a relationship manager 428 (such as the one (310) shown in FIG. 3, and being operably configured to perform its functionality as described above), and a selection manager 430 (such as the one (312) shown in FIG. 3, and being operably configured to perform its functionality as described above). The database 412 includes the following stores or repositories of data records: resource store 432 (such as the resource database 210 shown in FIG. 2, and being operably configured to perform its functionality as described above), account store 434 (such as the account database 302 shown in FIG. 3, and being operably configured to perform its functionality as described above), relationship store 436 (such as the relationship database 304 shown in FIG. 3, and being operably configured to perform its functionality as described above), and selection store 438 (such as the selection database 306 shown in FIG. 3, and being operably configured to perform its functionality as described above).

For instance, in one embodiment, the communications interface 414 (e.g., HyperText Transport Protocol (HTTP) interface) is operably configured to direct the information retrieval system to send and receive data and messages over a network via the I/O interface 404 (e.g., Transport Control Protocol (TCP) port interface) coupled to the network interface 406 (e.g., Internet Protocol (IP) network interface). The user interface 416 is operably configured to cause the information retrieval system to accept requests and present responses and notifications from and to users via devices coupled to the users. The input handler 418 is operably configured to cause the information retrieval system to process and interpret requests such as a query for information items, a request for submitting information items, and a request for associating an advertising information item with one or more referring or triggering information items. The response handler 420 is operably configured to cause the information retrieval system to prepare results in response to user requests, and make them available to the users via the user interface 416. Such results include a list of references (e.g., URLs) to information items in response to a query from a supplying user, a list of references to information items and another list of references to ads in response to a query from a consuming user, and an operation result status in response to a request for submitting information items in the resource store 432, or to a request for associating an advertising information item with one or more referring or triggering information items. The query engine 422 is operably configured to cause the information retrieval system to initiate a search of the resource store 432 for information items that meets criteria set forth in user requests or requests from other components or modules. The query engine 422 is also operably configured to cause the information retrieval system to search the account store 434, relationship store 436, and selection store 438 in accordance to criteria set forth in user requests or requests from other components or modules. The resource manager 424 is operably configured to cause the information retrieval system to create new data records in the resource store 432 for newly submitted information items. The account manager 426 is operably configured to cause the information retrieval system to create and update user account data records in the account store 434 in relation to user requests for account creation and update. The relationship manager 428 is operably configured to cause the information retrieval system to create and update relationship and association data records in the relationship store 436 in relation to user requests for associating a set of information items with another set of information items. The selection manager 430 is operably configured to cause the information retrieval system to determine the appropriate information items for advertising in relation to an information item chosen by a user, for example, based at least in part on relationships or associations between the user-chosen information item and other information items available in or through the information retrieval system, the relationships or associations having corresponding data records in the relationship store 436. The selection manager 430 is also operably configured to cause the information retrieval system to create and update in the selection store 438 the data records associated with the information items selected by the selection manager 430 and the data records associated with the user accounts relating to those system-selected information items. The resource store 432 is operably configured to store information item data records and related data, and handle operation requests from the resource manager 424 and other components or modules in the program memory 410. The account store 434 is operably configured to store user account data records and related data, and handle operation requests from the account manager 426 and other components or modules in the program memory 410. The relationship store 436 is operably configured to store relationship and association data records and related data, and handle operation requests from the relationship manager 428 and other components or modules in the program memory 410. The selection store 438 is operably configured to store selection data records and related data, and handle operation requests from the selection manager 430 and other components or modules in the program memory 410.

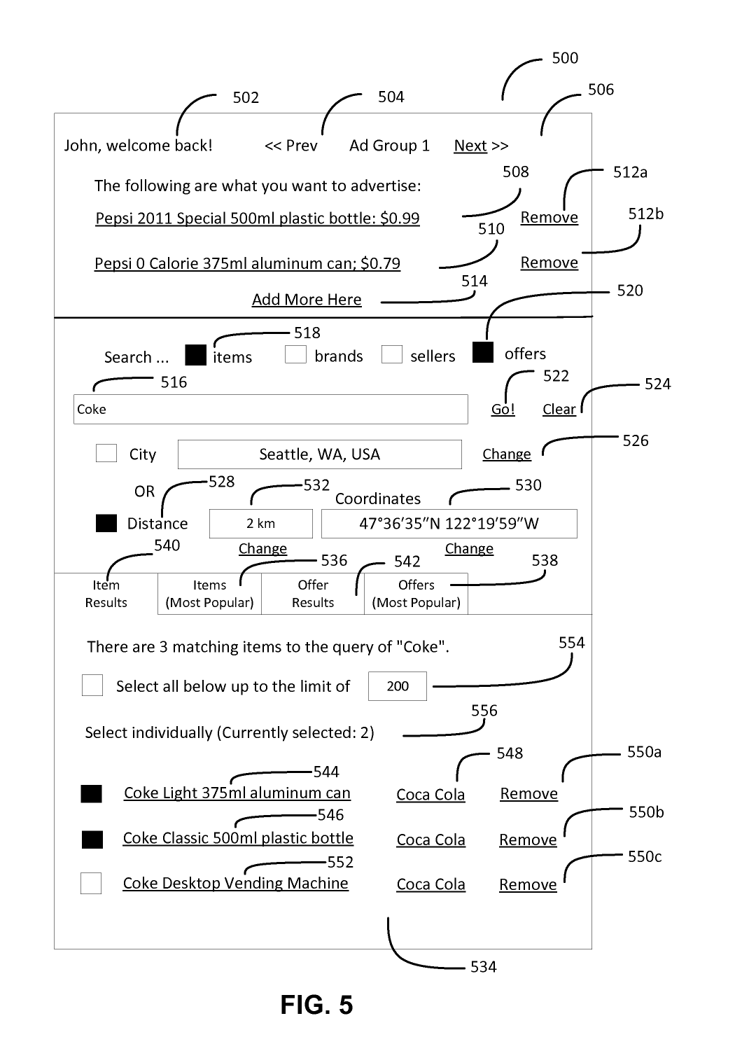

FIG. 5 is an example presentation or screenshot 500 that may appear on a device coupled to a supplying user, such as the device 106a coupled to the supplying user 102 shown in FIG. 1. At the top of the presentation 500 is a greeting message 502 to the user named “John” after he has successfully logged into his account at an information retrieval system embodying the present invention, such as the one (108) shown in FIG. 1. The user may navigate to his different ad groups associated with his account using the hypertexts “Prey” 504 (shown disabled) and “Next” 506. His ad group 1 shows two information items, or their references (e.g., in form of a hypertext or URL), associated with the user for advertising, namely the “Pepsi 2011 Special 500 ml . . . $0.99” ad 508 and “Pepsi 0 Calorie 375 ml . . . $0.79” ad 510. These ads or ad entries are hyperlinked so that the user may retrieve more information about them through their corresponding hypertexts. Each of these information items may include item information (e.g., product or service), seller information (e.g., a seller address associated with the user account; not shown), and price information. Quantity information assumes the value of one if not explicitly stated. An information item comprising item information, seller information, and price information may be regarded as an offer information item or an offer entry, the offer information item or offer entry including an item information item, a seller information item, and a price information item. In this embodiment, an item information item, or an item entry, includes brand information. In another embodiment, brand information is a separate information item or entry. The user may remove an ad from his ad group using the hypertext “Remove” 512a or 512b next to the ad, and add a new ad using the hypertext “Add More Here” 514.

To associate with his ad group 1 one or more information items available in the information retrieval system, the user first queries the system for information items of interest, and then selects from the results the one or more information items. For example, FIG. 5 shows that the user enters query input of “Coke” 516 for two types of information items, namely the “items” 518 and “offers” 520, among the four available types (items, brands, sellers, and offers). The user initiates the query by selecting the hypertext “Go!” 522. Or he may clear his query input through the hypertext “Clear” 524. In some embodiments, query input may be sent to the system, as it is being typed or provided, without the need for explicit confirmation from the user. In another embodiment, the information retrieval system may present the user one or more information items, without any specific queries beforehand, for the user to choose for association with his ads.

In addition to types of information items, FIG. 5 shows that the user may also qualify his information items of interest with other criteria, such as location by city or by distance (which in this embodiment is applicable only to seller and offer information items or entries). The user may change the city, distance and coordinates through their corresponding hypertext “Change” 526. FIG. 5 shows that the user selects location qualification by distance 528, with coordinates—47°36′ 35″ N. 122°19′ 59″ W. 530, and distance range of 2 kilometers 532. Having received this query with such location qualification, the information retrieval system returns a plurality of information items 534 per requested information type, as well as information items that the system deems popular for each of the type 536 or 538. The system may or may not consider the query or the location criteria when selecting these popular information items. Each set of results is displayed on an individual tabbed subarea, namely, Item Results 540, Items (Most Popular) 536, Offer Results 542, and Offers (Most Popular) 538. FIG. 5 shows the “Item Results” 540 tabbed subarea in view. There 554 and 556 respectively the user may select all the information item results up to a certain maximum limit (e.g., 200), or select each of them individually. FIG. 5 shows that the user has selected two information items, namely the product item “Coke Light 375 ml aluminum can” 544 and the product item “Coke Classic 500 ml plastic bottle” 546 respectively, both of brand “Coca Cola” 548. The user may also remove any results from the tabbed area (and thereby deselecting them if they're selected) through the hypertext “Remove” 550a, 550b, and 550c located at the end of each result entry. These result entries are hyperlinked so that the user may retrieve more information about them or access more functions in relation to them through their corresponding hypertexts 544, 546, and 552. As such, FIG. 5 shows how a user such as the supplying user 102 shown in FIG. 1 may associate his ads with one or more information items available in or through an information retrieval system embodying the present invention, so that the ads may be selected for presentation, or become a candidate for presentation, to another user when the one or more information items are determined to be of interest to the other user, for example, in response to a query of the other user, or as part of a chronological or spatial series of presentations initiated by the other user.

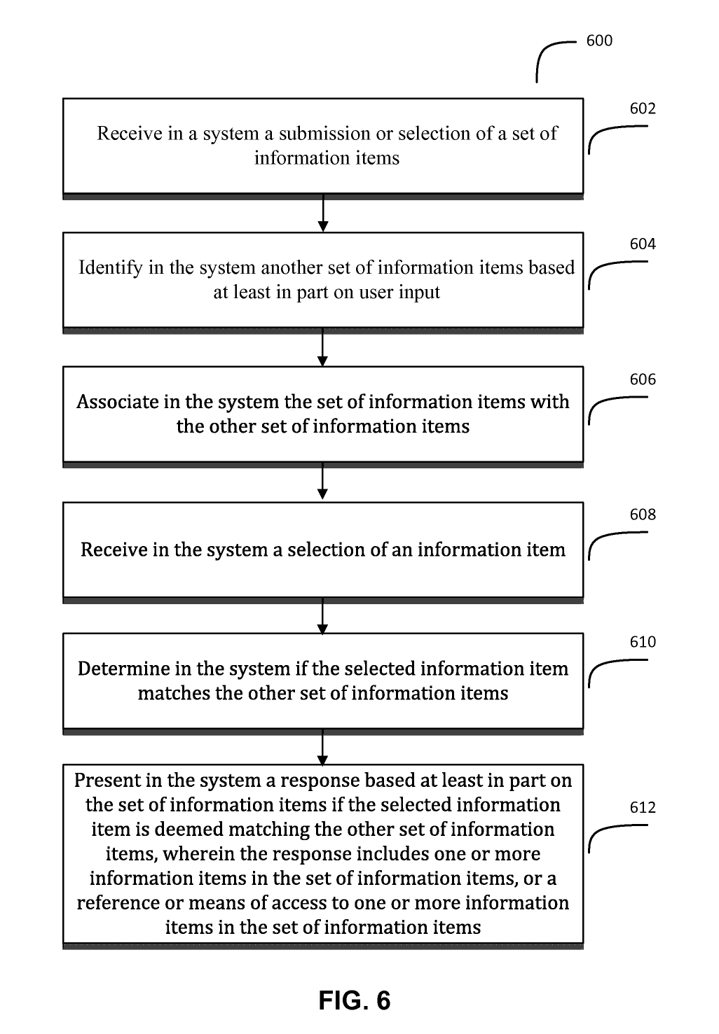

Referring to FIG. 6, a flow diagram of an example process 600 for advertising information items on behalf of a user to another user is provided. Per the example process 600, a submission or selection of a set of information items is received (602), wherein the set of information items may be available in or through an information retrieval system such as the one (108) shown in FIG. 1, and it may be associated with a user account in the information retrieval system. For example, the user interface 416 receives the logon request from a supplying user via the communications interface 414. It passes the logon credential contained in the logon request to the input handler 418 which in turn causes the account manager 426 to verify the logon credential using the data records in the account store. Upon successful verification, the account manager 426 notifies the response handler 420 of this result. The response handler 420 causes the account manager 426 to retrieve user account information from the account store 434 and the relationship manager 428 to retrieve from the relationship store 436 any relationships or associations that the user has with information items available in the resource store 432. The response handler 420 then causes the user interface 416 to present a graphical user interface (such as the one (500) shown in FIG. 5) to the supplying user via his coupled device. The input handler 418 may then receive via the user interface 416 a submission or selection of a set of information items from the supplying user. This set of information items, namely the ads associated with the supplying user account, such as the ad group 1 shown in FIG. 5, may already exist in the resource store 432. For instance, the response handler 420 via the user interface 416 may populate the graphical user interface on the device with information items previously submitted by the supplying user under his user account maintained in the account store 434, the information items thereafter being available in the resource store 432 and the relationships between the information items and the user account being stored in the relationship database 436. If any of the information items in the set does not yet exist in the resource store 432, the input handler causes the resource manager to add it in the resource store, and the association manager to associate it with the supplying user account. The input handler 418 may receive requests from the supplying user to add to his account-associated ad group (such as the ad group 1 shown in FIG. 5) one or more new information items not yet available in the resource store 432, select one or more existing ones from the resource store 432 to add to the ad group, or remove one or more information items from the ad group. In addition, the input handler 418 may receive from the supplying user a set of criteria associated with the set of information items, store the set of criteria in the resource store 432, and cause the relationship manager 428 to store in the relationship store 436 the relationships between the set of criteria and the set of information items. The relationship manager 428 and/or the selection manager 430 may then determine based at least in part on the set of criteria the eligibility of any information item, or parts thereof, or any user input, in triggering or otherwise implicating the set of information items for advertising. Examples of the set of criteria include a distance range relative to a geographical position, a set of cities, a set of countries, a set of genders, an age range, a score range, a set of identities, and a set of memberships. Alternatively, the input handler 418 may retrieve in the account store 434 via the account manager 426 the set of criteria from the user account associated with the supplying user. Target information or attributes to be subject to these criteria may be available in the information item or user input or relating to information about the consuming user, the information being available in the account store 434. Examples of such information or attributes include location information (e.g., a city name, a geographical point such as a Global Positioning System position or GPS position, a geographical area, and so on), time information (e.g., a time-stamp or range, calendar dates, time of day, and so on), and user information (e.g., age or age range, gender, membership, identity, purchase history, and so on).

Per the example process 600, another set of information items is identified based at least in part on user input (604), wherein the user input includes a submission or selection of the other set of information items from the supplying user, wherein the user input includes a query resulting in one or more information items in the other set of information items, wherein the user input includes the set of information items, and wherein the user input includes an information item selected by a consuming user. For example, the input handler 418 may receive references to the individual information items in the other set of information items from the user interface 416 that interacts with the supplying user via a graphical user interface such as the one (500) shown in FIG. 5. Or the input handler 418 may receive via the user interface 416 a query from the supplying user and cause the query engine 422 to search the resource store 432 for the other set of information items based at least in part on the query. Or the input handler 418 may cause the query engine 422 to search for the other set of information items in the resource store 432 based at least in part on the set of information items or the consuming user-selected information item, such as the constituent parts of each of the information item in the set or of the user-selected information item. In one embodiment, an operator or administrator of the information retrieval system may specify as the other set of information items a plurality of keywords in the relationship store. In another embodiment, the input handler 418 may cause the relationship manager 428 to discover common or shared information items based on information items in the resource store 432, and provide these common or shared information items as the other set of information items. The input handler 418 may also retrieve in the account store 434 or receive via the user interface 416 a limit, criterion, or constraint such as a maximum number, a city name, a location, and a geographical area. The query engine 422 will further subject information items that are candidate to being part of the other set of information items to such a limit, criterion, or constraint.

Per the example process 600, the set of information items is associated with the other set of information items (606). For example, the input handler 418 may cause the relationship manager 428 to create at least one data record in the relationship store 436 for associating the set of information items with the other set of information items.

Per the example process 600, a selection of an information item is received (608), wherein the information item is received from a consuming user, such as the one (104) shown in FIG. 1, and the consuming user is not associated with the supplying user account. For example, the input handler 418 may receive via the user interface 416 a query from the consuming user for information items. The input handler 418 causes the query engine 422 to search the resource store 432 for matching information items based at least in part on the query. The query engine 422 causes the response handler 420 to present via the user interface 416 one or more of the matching information items to the consuming user. The input handler 418 then receives via the user interface 416 from the user a selection of an information item among the one or more matching information items. In addition, the input handler 418 may receive from the consuming user another set of criteria associated with the selected information item, and cause the relationship manager 428 and/or the selection manager 430 to determine based at least in part on the other set of criteria the eligibility of the set of information items for presentation to the consuming user. Examples of the other set of criteria include a distance range relative to a geographical position, a city, a country, an affiliation, a certification, a quality mark, a minimum rating or score, and so on. Alternatively, the input handler 418 may retrieve in the account store 434 via the account manager 426 the other set of criteria from the user account associated with the consuming user. Target information or attributes to be subject to these criteria may be available in the individual information items in the set of information items for advertising or relating to information about the supplying user, the information being available in the account store 434. Examples of such target information or attributes include location information (e.g., a city name, a geographical point or area, and so on), time information (e.g., a time-stamp or range, calendar dates, time of day, and so on), seller information (e.g., a minimum customer satisfaction score or rating, a minimum number of sales, and so on), and price information (e.g., a price range).

Per the example process 600, whether the selected information item matches the other set of information items is determined (610). For example, the input handler 418 may cause the relationship manager 428 to search the relationship store 436 or the resource store 432 for data records indicating relationships or associations between the selected information item and the other set of information items. Examples of these relationships or associations include that the other set of information items includes or refers to the selected information item, that the selected information comprises or refers to at least one information item in the other set of information items, and that an information item in the other set of information items and the selected information item comprise or refer to the same information item, or an equivalent or comparable information item. In addition, the relationship manager 428 may check for availability of matching criteria associated with the set of information items and that of target information associated with the other set of information items, and determine if the target information meets the criteria. Likewise, the relationship manager 428 may check for availability of matching criteria associated with the other set of information items and that of target information associated with the set of information items, and determine if the target information meets the criteria. In one embodiment, only information items in the set of information items that pass both cases (or “directions”) of such determination are deemed matching with the other set of information items. In some embodiments, the selection manager 430 performs these criteria checking or matching. In other embodiments, it is the response handler 420.

Per the example process 600, a response based at least in part on the set of information items is presented if the selected information item is deemed matching the other set of information items (612), wherein the response includes one or more information items in the set of information items, or a reference or means of access to one or more information items in the set of information items, and wherein the response is presented to the consuming user via his coupled device. For example, the relationship manager 428 notifies the response handler 420 of the determination result. If there is a positive match, the response handler 420 causes the selection manager 430 to select one or more information items in the set of information items, and presents the one or more information items in connection with the selected information item to the consuming user via the user interface 416. Otherwise, the response handler 420 presents the selected information item to the consuming user without the set of information items. The presentation of the one or more information items for advertising includes a list of URLs each corresponding to one information item, an alert or software button through which the one or more information items or their URLs may be accessed, and so on.

It should be appreciated that the specific steps illustrated in FIG. 6 provide a particular method of advertising information items according to an embodiment of the present invention. Other sequences of steps may also be performed according to alternative embodiments. For instance, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications and still fall within the scope of various embodiments. One of ordinary skill in the art would recognize many variations, modifications, and alternatives.

For instance, the step of receiving a selection of an information item (608) may take place before the step of identifying another set of information items based at least in part on user input (604), for example, when the user input comprises, refers to, or includes the selected information item. Relationships or associations obtained in the step of associating the set of information items with the other set of information items (606) need not be stored in any database, for example, when they may be determined dynamically or on demand. Or the step of associating the set of information items with the other set of information items (606) may be omitted, for example, when the selected information item and a member in the set of information items comprise or refer to a common, equivalent, or relating information item, which composes, constitutes or functions as the other set of information items. The step of identifying another set of information items based at least in part on user input (604) may comprise, incorporate, eliminate, or replace the step of receiving a selection of an information item (608), for example, when the user input is the selection of the information item. The step of identifying another set of information items based at least in part on user input (604) may also comprise, incorporate, eliminate, or replace the step of determining if the selected information item matches the other set of information items (610), for example, when the set of information items are the other set of information items, the user input is the selected information item, and both the set of information items and the user input comprises or refers to a common, equivalent or otherwise relating information item.

In another embodiment, the step of associating the set of information items with the other set of information items (606) may be omitted or otherwise absorbed by other steps shown in FIG. 6. For example, the input handler 418 receives a submission or selection of an offer entry (i.e., the set of information items) when the supplying user fills in, selects, or uploads via his coupled device the offer entry comprising a plurality of parts (e.g., item entry, seller, entry, and price entry) or attributes (e.g., item name, brand name, seller name, city location, GPS position, postal code, and price). The input handler causes the resource manager (424) to create a data record for the offer entry if such data record does not yet exist. Each of these parts and/or attributes may readily be identifiable, for example, via the structure or template by which contents for these parts and attributes are specified, organized, or stored. These readily identifiable parts or attributes, and the contents therein, compose or otherwise constitute the other set of information items. When the input handler 418 receives via the user interface 416 a selection of an information item (e.g., another offer entry, a webpage, an article, a sound track, an image, a video, or a reference or URL to any of them) from the consuming user, the input handler 418 causes the resource manager 424 to compare the content of the selected information item with the contents of the readily identifiable parts or attributes, so to determine if the selected information item comprises or refers to contents in at least one of the readily identifiable parts or attributes. If so, then the resource manager 424 causes the selection manager 430 to retrieve the offer entry, and makes it available to the response handler 420 for presentation to the consuming user, unless the offer entry is also the selected information item. Alternatively, the input handler 418 causes the resource manager 424 to identify the individual parts or attributes, and contents therein (i.e., the other set of information items), and create at least one data record for the offer entry and at least another data record for the individual contents if such data records do not yet exist in the resource store 432. Each of the data records associated with the individual contents may be associated with an advertising cost or charge schedule, and may further be qualified (e.g., in form of name-value pair) by identification of their corresponding parts or attributes. This offer entry, as well as other offer entries in the resource store 432 from the same supplying user or other supplying users, is associated with the data records for these individual contents when these offer entries comprise these individual contents. When the input handler 418 receives a selection of information item, it causes the relationship manager 428 to determine if the selected information item comprises or refers at least one of these individual contents. If so, the relationship manager 428 causes the selection manager 430 to retrieve at least one offer entry and causes the response handler 420 to present the at least one offer entry to the consuming user, the at least one offer entry comprising or referring to the at least one of these individual contents. In some embodiments, the relationship manager 428 creates and maintains at least one data record for associating the offer entry (e.g., the set of information items) in the resource store 432 with the data records for individual part or attribute contents (e.g., the other set of information items), so to facilitate better performance and scalability in entry lookup and retrieval, such as using indexes. Or the relationship manager 428 may create such association data records only when the input handler 418 receives a request from the supplying user to associate the offer entry with the individual contents, so that the offer entry will be deemed matching the individual contents only if the corresponding association data records exist in the relationship store 436. Offer entries without such corresponding association data records will not be deemed matching even if they comprise or refer to the individual contents. In other embodiments, the resource manager 424 discovers or learns about the most frequently appearing or otherwise popular information parts or attributes, as well as their contents, based on a plurality of selected information items from various users, and builds up the other set of information items based at least in part on these popular information parts and attributes, as well as their contents.

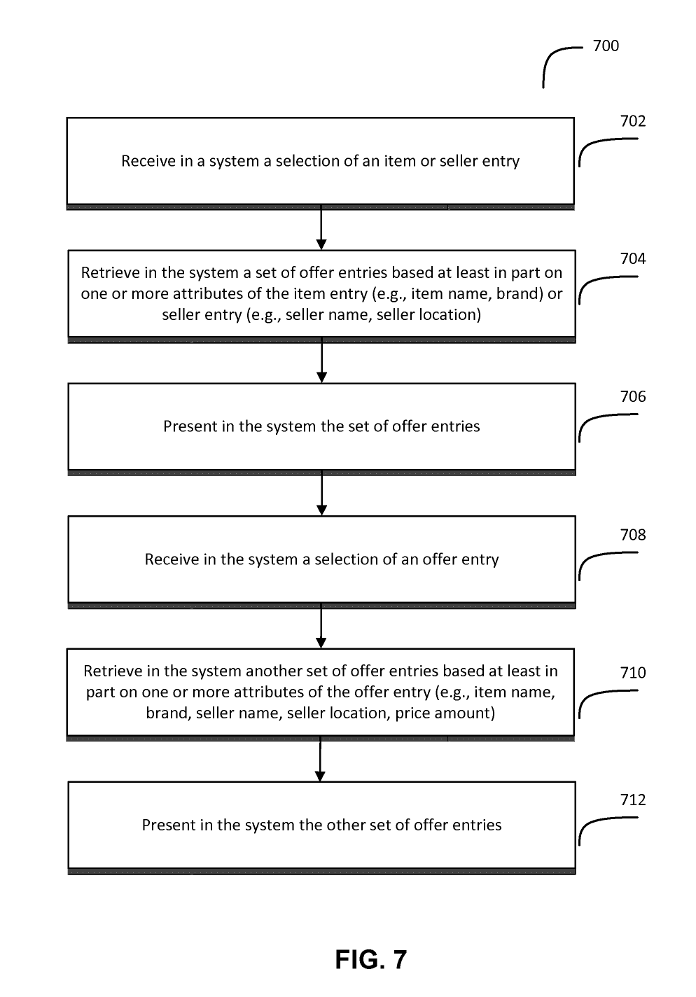

Referring to FIG. 7, a flow diagram of an example process 700 for advertising offer information items or entries is provided. In one embodiment, an offer information item or entry comprises an item entry (e.g., an entry comprising or referring to descriptions or identification of a product or service), a seller entry (e.g., an entry comprising or referring to descriptions or identification of a seller, the seller providing the product or service), and a price entry (e.g., an entry comprising or referring to price information), wherein the item entry comprises or refers to one or more information items or attributes, such as an item name and brand. Per the example process 700, a selection of an item entry is received (702), such as from the consuming user 104 shown in FIG. 1. The selection may be indicated by a reference, e.g., URL, to the item entry. For example, the input handler 418 receives via the user interface 416 a URL to an item or seller entry among a list of URLs to item or seller entries presented to a user through his coupled device (e.g., a mobile phone). In some embodiments, references to an item, seller, or offer entry are themselves regarded as item, seller, or offer entries.

Per the example process 700, a set of offer entries based at least in part on the selected item or seller entry is retrieved (704). For example, the input handler 418 causes the relationship manager 428 to search the relationship store 436 or the query engine 422 to search the resource store 432 for the set of offer entries based at least in part on one or more attributes of the selected item or seller entry. In one embodiment, the set of offer entries comprise or refer to the same or equivalent one or more attributes (and the contents therein) as the selected item or seller entry, but not being the same or equivalent to the selected item or seller entry. Examples of these attributes include name, brand, location, and so on. The input handler 418 may also cause the query engine 422 to search the resource store 432 for other offer entries that comprise or refer to the selected item or seller entry.

Per the example process 700, the set of offer entries, as well as the other offer entries, is presented (706). (In some embodiments, references to the offer entries in the set as well as to the other offer entries are presented instead.) For example, the relationship manager 428 or the query engine 422 notifies the response handler 420 of the availability of the set of offer entries. The response handler 420 causes the selection manager 430 to choose one or more offer entries in the set of offer entries, and presents via the user interface 416 the one or more offer entries to the user through his coupled device. In addition, the query engine 422 may also notify the response handler 420 of the availability of the other offer entries, and the response handler 420 may present via the user interface 416 the other offer entries to the user through his coupled device. The user interface 416 may present both groups of offer entries as a single list, two independent lists one for each group, a single list for the other offer entries while a software button (e.g., an ad button) for access to the set of offer entries, and so on.

Per the example process 700, a selection of an offer entry is received (708). For example, the input handler 418 receives via the user interface 416 a reference, such as a URL, to an offer entry chosen by the user among the set of offer entries or the other offer entries (or their references) presented on the device coupled to the user.

Per the example process 700, another set of offer entries based at least in part on one or more attributes of the offer entry is retrieved (710). For example, the input handler 418 causes the relationship manager 428 to search the relationship store 436 or the query engine 422 to search the resource store 432 for the other set of offer entries based at least in part on one or more attributes of the selected offer entry. In one embodiment, the other set of offer entries comprise or refer to the same or equivalent one or more attributes (and the contents therein) as the selected offer entry, but not being the same or equivalent to the selected offer entry. Examples of these attributes include name, brand, location, price, and so on. The input handler 418 may also cause the query engine 422 to retrieve the contents of the selected offer entry in the resource store 432 or in an external or third-party information provider via a reference to the selected offer entry, such as a URL.

Per the example process 700, the other set of offer entries, as well as the contents of the selected offer entry, is presented (712). (In some embodiments, references to the other set of offer entries are presented instead.) For example, the relationship manager 428 or the query engine 422 notifies the response handler 420 of the availability of the other set of offer entries. The response handler 420 causes the selection manager 430 to choose one or more offer entries in the other set of offer entries, and presents via the user interface 416 the one or more offer entries to the user through his coupled device. In addition, the query engine 422 may also notify the response handler 420 of the availability of the contents of the selected offer entry, and the response handler 420 may present via the user interface 416 the contents of the selected offer entry to the user through his coupled device. The user interface 416 may present the one or more offer entries and the contents of the selected offer entry on the same graphical user interface (GUI), or just the contents of the selected offer entry on the GUI including a software button (e.g., an ad button) for access to the one or more offer entries, and so on.

It should be appreciated that the specific steps illustrated in FIG. 7 provide a particular method of advertising offer information items or entries according to an embodiment of the present invention. Other sequences of steps may also be performed according to alternative embodiments. For instance, alternative embodiments of the present invention may perform the steps outlined above in a different order. Moreover, the individual steps illustrated in FIG. 7 may include multiple sub-steps that may be performed in various sequences as appropriate to the individual step. Furthermore, additional steps may be added or removed depending on the particular applications and still fall within the scope of various embodiments. One of ordinary skill in the art would recognize many variations, modifications, and alternatives. For example, the example process 700 may repeat itself for any item, offer or seller entry selected by the user through the device to which he is coupled. In some embodiments, attributes of an entry, such as a brand name of an item, may be regarded as information items or entries composing the entry.

In some embodiments, there may be more information items or ads from the supplying user(s) that are qualified for presentation to the consuming user than what may be allowed under certain constraints. Example constraints include the maximum number of information items or ads (or their references such as URLs) that may be presented on a single screen or online page, the maximum time duration that consecutive information items or ads may be presented visually or audibly (e.g., in between two otherwise successive contents), and so on. Any selection criterion, policy or scheme for selecting information items or ads from a set of qualified information items or ads for presentation to the consuming user is within the scope of various embodiments. For example, the relationship manager 428 notifies the selection manager 430 of a set of qualified information items or ads. The selection manager 428 selects a subset from the set of qualified information items or ads in accordance to some selection criteria, policies or schemes whose data are accessible and maintained in the selection store 438 or any other storage, and causes the response handler 420 to present via the user interface 416 the subset of qualified information items or ads to the consuming user through his coupled device. Example criteria, policies and schemes include round robin, highest bid first, highest budget first, or a combination thereof. A set of ads may be associated with a user account such as a supplying user account in the account store 434. Advertising budgets and limits may be associated with the set of ads, and such budgets and limits may be stored and maintained in the user account. Some or all of these advertising budgets or limits may be specific to certain selection criteria, policies and schemes.

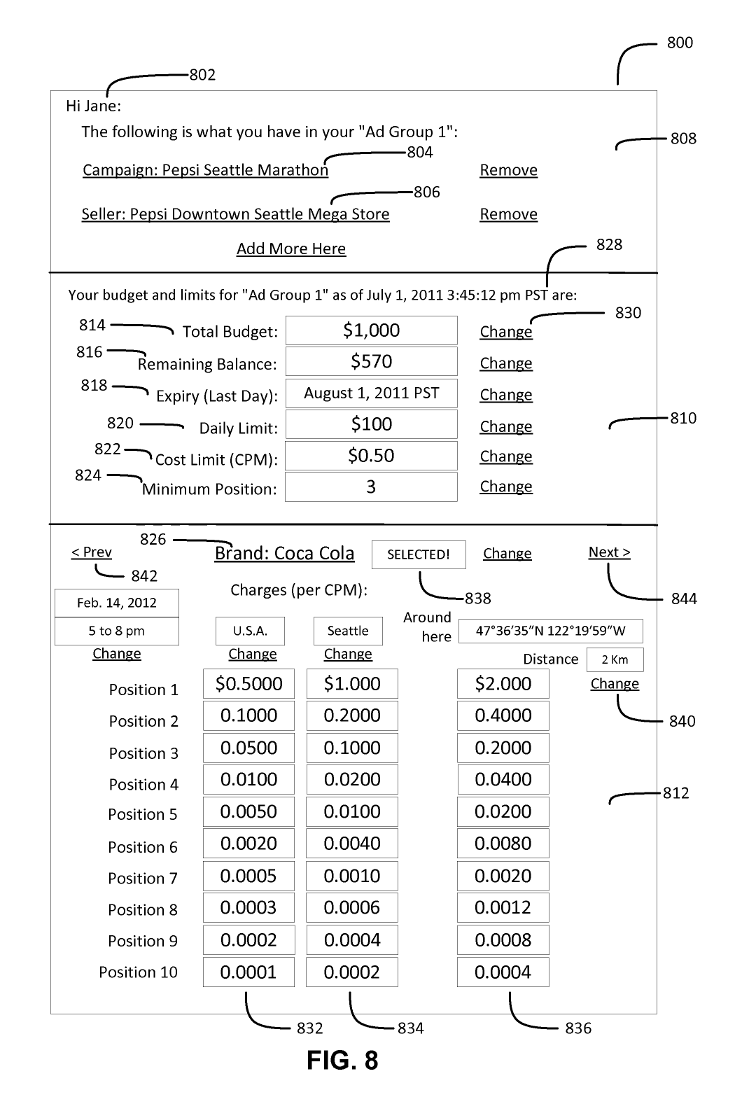

FIG. 8 is an example presentation or screenshot 800 that an information retrieval system equipped with the present invention may present to a user through a device to which she is coupled, such as the information retrieval system 108 and the supplying user 102 shown in FIG. 1. The example presentation or screenshot 800 shows how the user (e.g., “Jane” 802 as shown in FIG. 8) may provide advertising budgets and limits, or selection-related data, for her ads (e.g., the two ads “Campaign: Pepsi Seattle Marathon” 804 and “Seller: Pepsi Downtown Seattle Mega Store” 806 shown in FIG. 8), and how the information retrieval system may present various advertising costs associated with presenting ads in relation to a particular information item or group of information items. For example, the user may be presented with a screen or view such as the one (800) shown in FIG. 8 when she selects a “Coca Cola” hypertext on a GUI such as the one (500) shown in FIG. 5. The presentation 800 in FIG. 8 shows three horizontal sections 808, 810, 812 of information. The first section 808 displays the individual ads 804 and 806 in the user's so-called “Ad Group 1”. The second section 810 displays the user's current budget and settings for “Ad Group 1” (e.g., advertising budgets, remaining balances, limits, or any selection-related data, for “Ad Group 1”, such as total budget 814, remaining balance 816, expiry date 818, daily limit 820, cost limit 822, minimum position 824). The third section 812 enables the user to navigate to a number of information items and displays the costs associated with presenting ads in relation to these information items under some conditions or criteria. For example, upon receiving via the user interface 416 the selection of the “Coca Cola” hypertext from the user, the input handler 418 causes the account manager 426 to retrieve the data record(s) in the account store 434 for “Ad Group 1”, and causes the query engine 422 to retrieve the ads in the resource store 432 in relation to the data record(s). The input handler 418 notifies the response handler 420 of the availability of these ads, and the response handler 420 presents via the user interface 416 the ads or references to the ads to the user. In addition, the input handler 418 causes the account manager 426 to retrieve data record(s) in the account store 434 for information about the budgets and limits associated with “Ad Group 1”, and causes the response handler 420 to present via the user interface 416 the advertising budget and limits information. Furthermore, the input handler 418 causes the relationship manager 428 to retrieve relationship data records that associate an information item (e.g., the brand “Coca Cola” 826) with the advertising costs for presenting ads in relation to that information item, and causes the selection manager 430 to retrieve advertising cost data records in the selection store 438 based at least in part on these relationship data records. The advertising cost data may be manually entered by an administrator or operator of the information retrieval system, or any personnel authorized to do so, automatically generated based on usage and interests in relation to the information item in question as determined by the information retrieval system or any third-party system, or a combination thereof. Any means of obtaining or generating data on advertising costs for advertising in relation to an information item is within the scope of various embodiments.

FIG. 8 shows an example advertising budget and limits available in data records associated with a set of ads (e.g., “Ad Group 1”) that are stored in a user account (e.g., the user account of “Jane” in the account store 434). The total budget 814 (e.g., $1,000) indicates the maximum amount of money that is allocated for payments for advertising the set of ads. The remaining balance 816 (e.g., $570) indicates the remainder of the budget available for advertising payments as of a certain timestamp 828 (e.g., Jul. 1, 2011 3:45:12 pm PST). The expiry 818 (e.g., Aug. 1, 2011 PST) indicates the day after which the advertising for the set of ads will stop. The daily limit 820 (e.g., $100) indicates the maximum amount of charges allowed in a single calendar day. The cost limit 822 (e.g., $0.50) indicates the maximum amount allowed to be charged per some advertising event, namely CPM (Cost Per Thousand Impressions), or some other schemes such as CPC (Cost Per Click Through), CPS (Cost Per Sale), and so on. The minimum position 824 (e.g., 3) indicates the lowest position that the set of ads is intended to occupy if selected for presentation in an ordered list of ads to the user. The user may change any of these settings through the hyperlinked text (e.g., “Change” 830) next to each of these settings.

FIG. 8 also shows an example schedule of advertising costs in relation to an information item (e.g., the brand “Coca Cola” 826). As shown in FIG. 8, a combination of conditions or criteria determines a specific schedule of advertising costs. For example, FIG. 8 shows three different schedules 832, 834, 836, each associated with a location and a time period. Each of these schedules lists the individual rate of charge for each position per CPM, applicable to ads being presented to a user in the specific location and the specific time period. FIG. 8 shows three schedules of charges, one (832) for the location of U.S.A. and the period between 5 to 8 pm on Feb. 14, 2012, a second one (834) for the location of the City of Seattle and the same period, and a third one (836) for the location of a range of 2 kilometers from the GPS position 47°36′ 35″ N. 122°19′ 59″ W. and the same period. If multiple cost schedules are deemed applicable, the one with the highest rates applies. Any condition or criterion for determining schedules of advertising costs is within the scope of various embodiments. For example, different information items may be associated with different cost schedules even for the same location and time period based on, for example, their popularity to consuming users as well as supplying users.

FIG. 8 also shows that the information item in question (i.e., the brand “Coca Cola” 826) is currently associated with the ads in “Ad Group 1” (i.e., via the “SELECTED!” 838 indicator), so that if a consuming user indicates interest in that information item, the ads will be a candidate for presentation to the consuming user. The supplying user (i.e., “Jane” 802) may remove this information item association, or look up advertising cost schedules for different locations or time periods for the same information time through their corresponding hyperlinked text for such action (e.g., “Change” 840). The supplying user may also select another information item and views its associated advertising cost schedules through the hyperlinked texts for such action (e.g., “<Prey” 842 and “Next>” 844). In some embodiments, the user interface may provide a query interface for a supplying user to search information items and their associated advertising cost schedules.

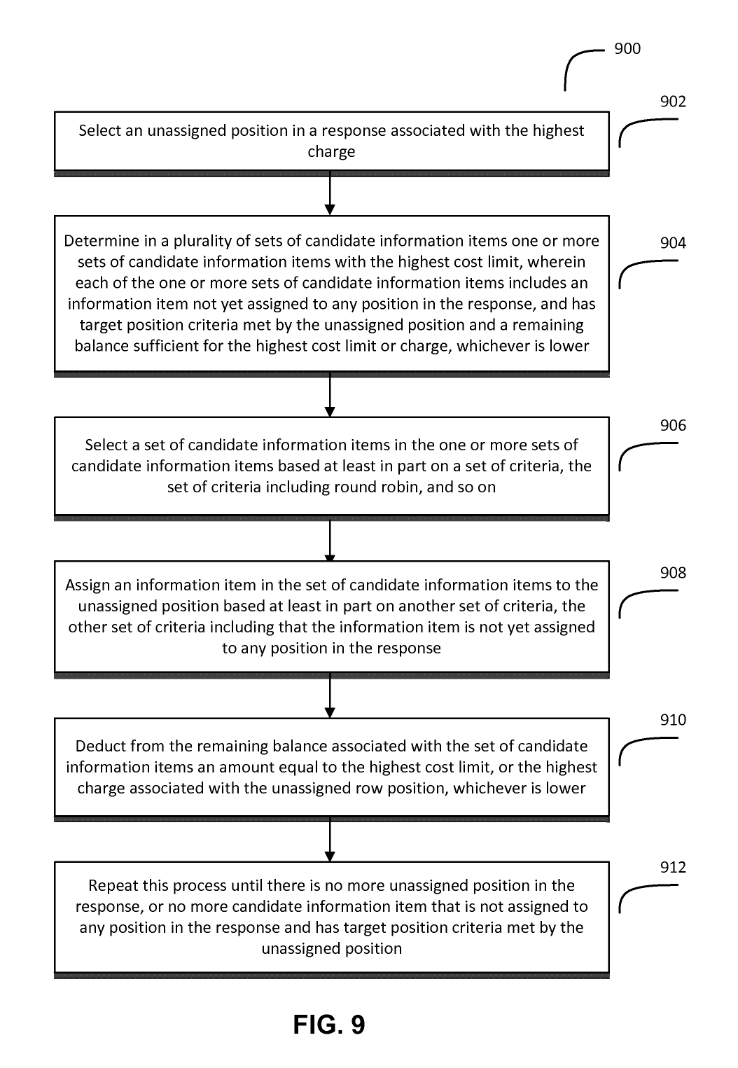

Referring to FIG. 9, a flow diagram of an example process 900 for selecting information items from a plurality of sets of candidate information items, and prioritizing them (e.g., for presentation) in a response to a user, such as presenting them in a list of prioritized positions of limited availability. Each set of candidate information items is associated with its own advertising budget, limits and any selection-related data, as may be stored and maintained in a user account. For example, the response handler 420 may be configured to present up to ten ads in form of a top-down list to the consuming user in response to the user's selection of an information item. The selection manager 430 is configured to select ads to fill the list, with the higher position being more valuable, and to determine which ads to select when there are more than 10 candidate ads in the resource store. Per the example process 900, an unassigned position in an ads-carrying response associated with the highest charge is selected (902). For example, the selection manager 430 creates a response data record in the selection store 438. It retrieves in the selection store 438 the advertising cost schedule associated with the information item selected by the user, as well as other conditions or criteria, such as the GPS position of the device coupled to the user, and the time of day of the user selection. The response data record comprises a plurality of positions, each being associated by the selection manager with a charge in accordance to the advertising cost schedule in accordance to applicable conditions, criteria, or constraints as described above. The selection manager 430 identifies in the response an unassigned position associated with the highest charge.

Per the example process 900, one or more sets of candidate information items with the highest cost limit in a plurality of sets of candidate information items is determined (904). Each of the one or more sets of candidate information items includes an information item not yet assigned to any position in the response, and has target position criteria met by the unassigned position and a remaining balance sufficient for the highest cost limit or the highest charge, whichever is lower. For example, the selection manager (430) retrieves in the account store 434 the cost limits of the candidate ads or of the sets of candidate ads, and determines the highest cost limit among them. It identifies one or more candidate ads or sets of candidate ads associated with the highest cost limit. Candidate ads or entire sets of candidate ads already assigned a position in the response (and their cost limits) may be ignored. Candidate ads or entire sets of candidate ads whose target position criteria not met by the unassigned position (and their cost limits), or those whose remaining balance is sufficient for neither the highest limit nor the highest charge (and their cost limits), may also be ignored.

Per the example process 900, a set of candidate information items is selected in the one or more sets of candidate information items based at least in part on a set of criteria, the set of criteria including round robin (906). For example, the selection manager 430 selects the set of candidate ads for the unassigned position in the response if it determines that there is only one such set. When there is a plurality of matching sets, then the selection manager 430 selects one of the matching sets based at least in part on some criteria, such as round robin, highest remaining balance first, highest budget first, and so on. The selection manager 430 maintains working data as well as history of selections in the selection store 438.

Per the example process 900, an information item in the set of candidate information items is assigned to the unassigned position based at least in part on another set of criteria (908). For example, the selection manager 430 assigns the candidate ad to the unassigned row position in the response if it determines that there is only one ad in the set of candidate ads. When there is plurality of ads in the set, then the selection manager 430 may select one of the candidate ads based at least in part on some criteria, such round robin, user-specified priority, and so on. Ads in the set that have already been assigned a position in the response are ignored.

Per the example process 900, an amount equal to the highest cost limit, or the highest charge associated with the unassigned row position, whichever is lower, is deducted from the remaining balance associated with the set of candidate information items (910). For example, the selection manager 430 causes the account manager 426 to deduct from the remaining balance associated with the set of candidate ads an amount equal to the highest cost limit, or the highest charge associated with the unassigned row position, whichever is lower.

Per the example process 900, the steps described earlier may be repeated until there is no more unassigned position in the response, or no more candidate information item that is not assigned to any position in the response and has target position criteria met by the unassigned position (912). For example, the selection manager 430 repeats the steps described above for each unassigned position in the response, until all positions are assigned with an ad, or there are no more qualified ads.

In some embodiments, the response may comprise a plurality of positions that are associated with the same advertising cost or charge. Advertising costs, budgets, and limits need not be monetary. Points, scores or some system-generated metrics may also be used to qualify advertising costs, budgets, and limits. Cost limits may also be specified individually per some target position in the response, and advertising charges may also be specified relative to different positions in the response based on a base amount, such as $0.005 for the lowest position, with charges for higher positions being a multiple of that base amount.

It should be appreciated that the specific steps illustrated in FIG. 9 provide a particular method of prioritizing or selecting information items for advertising according to an embodiment of the present invention. Other sequences of steps may also be performed according to alternative embodiments. For instance, alternative embodiments of the present invention may perform the steps outlined above in a different order. Moreover, the individual steps illustrated in FIG. 9 may include multiple sub-steps that may be performed in various sequences as appropriate to the individual step. Furthermore, additional steps may be added or removed depending on the particular applications and still fall within the scope of various embodiments. One of ordinary skill in the art would recognize many variations, modifications, and alternatives. For example, the step of selecting a set of candidate information items in the one or more sets of candidate information items based at least in part on a set of criteria (906) and the step of assigning an information item in the set of candidate information items to the unassigned position based at least in part on another set of criteria (908) may be combined, for example, when the set of candidate information items has only one information item, and the selecting includes assigning the selected set of candidate information items to the unassigned position in the response.

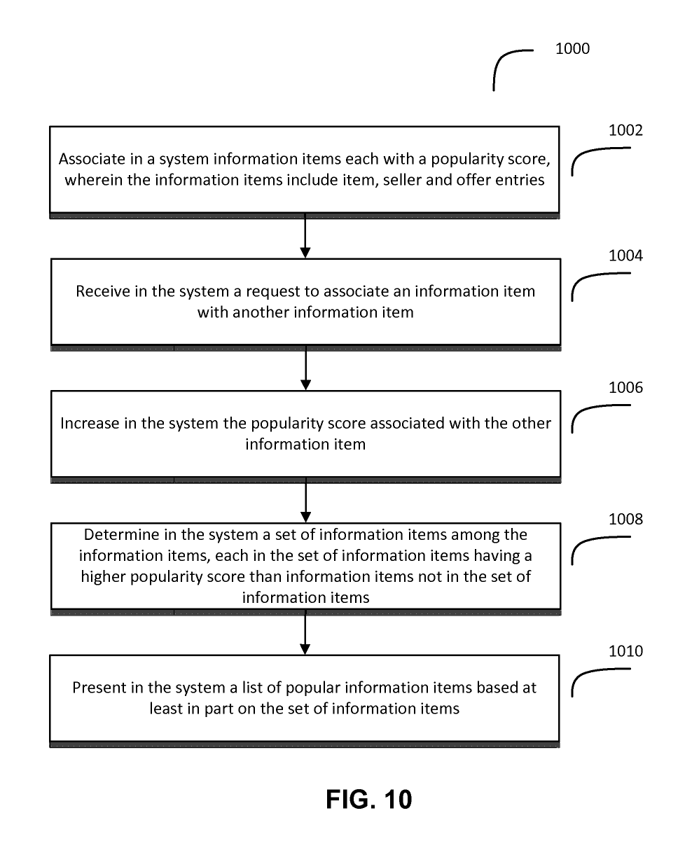

Referring to FIG. 10, a flow diagram of an example process 1000 for determining the popularity of an information item is shown. Per the example process 1000, a popularity score is associated with each of the information system available in an information retrieval system (1002). For example, the resource manager 424 creates a popularity data record in the resource store 432 for each information item therein. The resource store 432 may comprise information items of various types, such as item (e.g., product or service), seller and offer. Any type of information item is within the scope of various embodiments.

Per the example process 1000, a request to associate an information item with another information is received (1004). For example, the input handler 418 receives via the user interface 416 a request from a user such as the supplying user 102 shown in FIG. 1 to associate an ad in his user account with another information item available in the resource store 432, so that the ad would become a candidate for presentation to the user when the user selects the other information item.

Per the example process 1000, the popularity score associated with the other information item is increased (1006). For example, the input handler 418 causes the resource manager 424 to increase the popularity score maintained in the popularity data record associated with the other information item.

Per the example process 1000, a set of information items each having a higher popularity score than other information items not in the set is determined (1008). For example, upon a request from the response handler 420 in its preparation for presenting a GUI to a user, such as the one (500) shown in FIG. 5, the resource manager 424 retrieves information items with the highest popularity scores, in conjunction to any other applicable criteria, if any, such as belonging to specific brands or sellers.

Per the example process 1000, a list of popular information items based at least in part on the set of information items is presented (1010). For example, upon notification by the resource manager 424 of the information items with the highest popularity scores, the response handler 420 may choose a subset of the information items for presentation to the user, such as via a GUI similar to the one (500) shown in FIG. 5. In another embodiment, the resource manager 424 causes the selection manager 430 to increase the individual amounts in the advertising cost schedules associated with the information items based on their popularity scores. Any process for determining the popularity of an information item is within the scope of various embodiments.

It should be appreciated that the specific steps illustrated in FIG. 10 provide a particular method of determining the popularity of an information item based at least in part on another set of information items according to an embodiment of the present invention. Other sequences of steps may also be performed according to alternative embodiments. For instance, alternative embodiments of the present invention may perform the steps outlined above in a different order. Moreover, the individual steps illustrated in FIG. 10 may include multiple sub-steps that may be performed in various sequences as appropriate to the individual step. Furthermore, additional steps may be added or removed depending on the particular applications and still fall within the scope of various embodiments. One of ordinary skill in the art would recognize many variations, modifications, and alternatives.

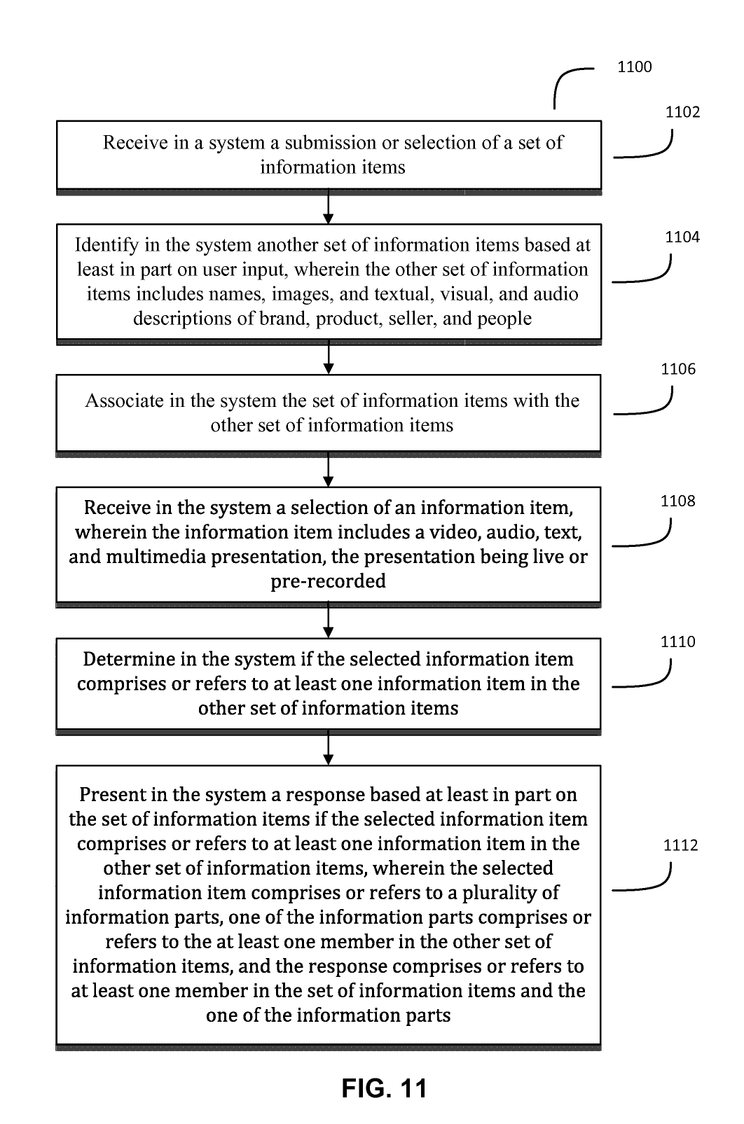

Referring to FIG. 11, a flow diagram of an example process 1100 for advertising a set of information items based at least in part on another set of information items is shown. Per the example process 1100, a submission of a set of information items is received (1102). For example, the input handler 418 receives via the user interface 416 a submission or selection of a set of information items (e.g., a set of online ads), where the set of information items may or may not exist in the resource store 432. The input handler 418 causes the resource manager 424 to create data records in the resource store 432 to store any of the information items in the set not yet available therein.

Per the example process 1100, another set of information items based at least in part on user input is identified (1104), wherein the user input includes submissions or selections of information items from a user, such as the supplying user 102 or consuming user 104 shown in FIG. 1, or any other user. The other set of information items may include tags, keywords, and descriptions, such as names, images, and textual, visual, and audio descriptions of brand, product, seller, and people. For example, the input handler 418 receives via the user interface 416 a submission or selection of a set of names and images of brand and product, from an administrator of the information retrieval system. The submission or selection may include other information such as advertising costs associated with the names and images. The input handler 418 causes the resource manager 424 to create data records in the resource store 432 to store any of the names and images not yet available therein, as well as their related data. In another embodiment, the user input may be the set of information items described in the above step of receiving (1102), or a submission or selection of an information item of interest to the user, such as the information item described in the step of receiving a selection of an information item below (1108). For example, the input handler 418 causes the relationship manager 428 to identify in the user input some specific tags, keywords, or descriptions available in the relationship store 436 or resource store 432, or words or pieces of content that appear in high frequency relative to other words or pieces of content in a collection of information items in the resource store 432.

Per the example process 1100, the set of information items is associated with the other set of information items (1106). For example, the input handler 418 causes the relationship manager 428 to identify one or more information items in the set of information items that comprise or refer to at least one information item in the other set of information items, and to create in the relationship store 436 at least one data record that associates the one or more information items (in the set) with the at least one information item (in the other set). Alternatively, the input handler 418 may receive via the user interface 416 a request to associate the set of information items with the other set of information items, and cause the relationship manager 428 to create in the relationship store 436 at least one data record that indicates this association. In one embodiment, the set of information items must comprise or refer to at least one information item in the other set. In another embodiment, there is no such constraint. Each information item in the other set may be associated with an advertising cost.

Per the example process 1100, a selection of an information item is received (1108), wherein the information item includes a video, audio, text, and multimedia presentation, the presentation being live or pre-recorded. For example, the input handler 418 receives a request for an information item, such as a user's selection of a URL to that information item, and causes the query engine 422 to retrieve the requested information item. In some embodiments, the user input described above is the selected information item.

Per the example process 1100, whether the selected information item comprises or refers to at least one information item in the other set of information items is determined (1110). For example, the relationship manager 428 determines if the selected information comprises or refers to any of the information items in the other set, for example, a set of names and images of brand and product composing the other set of information items. Such determination or processing may be performed periodically, by schedule, or on demand, for example, when the selected information item is retrieved from the resource store 432, when it is first received by the input handler 418 or when requested by the administrator of the information retrieval system.

Per the example process 1100, a response based at least in part on the set of information items is presented if the selected information item is deemed comprising or referring to at least one information item in the other set of information items (1112), wherein the response includes one or more information items in the set of information items, and the selected information item, and wherein the selected information item comprises or refers to a plurality of information parts, one of the information parts comprises or refers to the at least one member in the other set of information items, and the response comprises or refers to at least one member in the set of information items and the one of the information parts. For example, the relationship manager 428 determines that the selected information item comprises or refers to at least one information item in the other set of information items. It causes the response handler 420 to prepare and present based at least in part on the set of information items a response for presentation to a user such as the consuming user 104 shown in FIG. 1. In some embodiments, the response handler 420 causes the selection manager 430 to select one information item (e.g., an ad) in the set of information items (e.g., the set of ads) and presents the system-selected information item in parallel to the user-selected information item (e.g., a video, audio, text, and multimedia presentation, whether live or pre-recorded), or as interstitials to the user-selected information item. For instance, a plurality of user contents (i.e., information parts) in the resource store may be associated with the selected information item (e.g., a URL) of user interest, wherein the plurality of user contents is or otherwise refers to a chronological or spatial series of parts, segments or sections composing or referring to the selected information item of user interest. For each user content in the plurality of user contents, the response handler 420 causes the relationship manager 428 to determine if the user content comprises at least one information item available in the other set of information items (e.g., brand, product, seller and people names or images). If so, the response handler 420 causes the selection manager 430 to select one or more information items in the set of information items (e.g., ads) and presents via the user interface the one or more information items (e.g., selected ads) either before or after the user content. In one embodiment, the response handler 420 repeats this process for each piece of user content in the presentation of the spatial or chronological series of user contents without further user input. The selection manager 430 provides notifications of available ads to the response handler 420 without further instructions from the response handler 420. In some embodiments, information items or ads selected in relation to a particular piece of user content are presented in connection with that piece of user content, such as spatially (e.g., appearing on the same screen or visual area) or chronologically (e.g., appearing right before or after the piece of user content). Criteria for selecting the one or more ads among the set of candidate ads include the budgets, remaining balances, cost limits, running times, spatial dimensions or areas, and so on, that may be associated with the candidate ads. Any selection criterion is within the scope of various embodiments.

It should be appreciated that the specific steps illustrated in FIG. 11 provide a particular method of advertising a set of information items based at least in part on another set of information items according to an embodiment of the present invention. Other sequences of steps may also be performed according to alternative embodiments. For instance, alternative embodiments of the present invention may perform the steps outlined above in a different order. Moreover, the individual steps illustrated in FIG. 11 may include multiple sub-steps that may be performed in various sequences as appropriate to the individual step. Furthermore, additional steps may be added or removed depending on the particular applications and still fall within the scope of various embodiments. One of ordinary skill in the art would recognize many variations, modifications, and alternatives. For example, the step of receiving a selection of an information item (1108) may be omitted, skipped or otherwise combined, for example, when the user input is the selection of an information item, or the information item itself. Or the step of the associating the set of information items with the other set of information items (1106) may be combined with the step of determining if the selected information item comprises or refers to at least one information item in the other set of information items (1110), for example, when the set of information items is searched for determining if any member in the set comprises or refers to at least one information item in the other set at the same step of the determining (1110). Or the step of receiving a submission or selection of a set of information items (1102) may take place after the step of identifying another set of information items based at least in part on user input (1104), for example, when the subsequent step of associating the set of information items with the other set of information items (1106) includes searching the set of information items (e.g., set of ads) for matching information items in the other set of information items (e.g., set of keywords or images), and performing the associating based on the matching information items.

Various embodiments of how the system can be employed for different advertising applications have been provided. It will be appreciated that the system can be adapted to accommodate other applications of advertising for virtually any types or combinations of information items. For example, a search engine equipped with the present invention may allow its users to associate their online ads (in form of banner, URL, and so on) with URLs to webpages, websites, products, brands, offers, events, and so on. Popular webpages or websites are associated with higher advertising costs. The search engine prepares a search results page in response to a query from another user, where each search result comprises a URL. Online ads having associations with the search results become a candidate for inclusion into the search results page. The search engine then chooses a subset of the candidate online ads based on some specific selection criteria and includes them in the search results page for presentation to the other user. When the other user selects a particular search result (e.g., URL) in the search results page, the search engine may further select online ads associated with the selected search result and present them in connection with the contents of the selected search result, for example, as interstitials or concurrent contents. An ad may also be associated with a plurality of information items such that the ad will become a candidate for presentation only if a user may selected more than one information items in the plurality of information items per some criteria, such as within the same request for information items, within a given period of time, within a certain number of requests, selections, or clicks, and so on.

The present invention provides methods and systems, among other uses or applications, for accepting a set of information items from a user, relating the set of information items to another set of information items, receiving a selection of an information item from another user, and presenting a response to the other user based at least in part on the set of information items if the selected information item comprises or refers to at least one information item in the other set of information items. Such methods and systems make it possible for sellers and advertisers to expressly identify information items most relevant to their ads and make the ads available for presentation in connection with the information items when one of the information items is selected by or otherwise presented to a consumer. Some embodiments of the present invention also enable sellers and advertisers to use their product, service, brand, seller, and offer entries as ads, so that no or minimal extraneous information or effort is required for ad production.

For instance, a shopping information retrieval system or search engine may retrieve these entries in response to a user's request or query, and only present them as ads in connection to other entries when the user requests or queries for the other entries. In one embodiment, the constituent parts of the entries provide data of association or relationship with other entries available in the system or engine, and facilitate auto discovery for relevance without no or minimal manual intervention. Another embodiment enables sellers and advertisers to easily specify their budgets and cost limits amidst fluctuating advertising costs or charges associated with information items of their interest in ads association, and benefit from having their ads placed in a more expensive position than what's incurred against their budgets or otherwise committed by their cost limits. Yet another embodiment is also capable of determining a popularity score of an information item based on requests for ad associations from sellers and advertisers, and determining a set of popular information items relevant to the sellers and advertisers based at least in part on such popularity scores. An embodiment may also adjust or evaluate advertising costs relating to having ads associated with individual information items based at least in part on such popularity scores of these individual information items.

In addition, an advertising system embodying the present invention may present to a seller (for example, in response to a query or a command from a user, a trigger from a third party, or a system-controlled notification, playback or streaming) a set of information items (e.g., product, brand, seller, or event information), where the seller is associated with an account. Each information item may be associated with cost information, the cost information including a charge rate for presenting an ad in relation to the information item. The advertising system may receive from the consumer a selection of one or more information items from the set, the one or more information items being associated with an ad chargeable to the account of the seller. For example, the consumer may submit his choice of such ads along with his selection of these information items, or indicate to the system such choices before or after the selection. The system would associate the ads with the selected information items, and determine rate information based on the cost information, the rate information including how to calculate for each presentation or impression of the ads. In an embodiment, the rate information may be the same as the cost information. The system may also present another set of information items to a consumer, and detect the presentation of one of these information items to the consumer. For example, the consumer may select an online entry or hyperlinked text among the entries or hyperlinked texts presented or otherwise tracked by the system. If the entry or hyperlinked text so selected by the consumer refers to or otherwise relates to the information items selected by the seller for association with his ad, then the ad would be presented to the consumer. (According to one embodiment, the consumer may not need to explicitly select or otherwise identify a particular information item of interest. For example, the consumer may be watching a video or a slide show that presents an ad-triggered information item only 10 minutes or 5 slides after the show has begun.) A charge based on the rate information would be applied to the account of the seller. In one embodiment, such charges are not applied until a specific number of presentations or a specific billing period has been reached.

According to another embodiment, the advertising system may receive from the seller a submission or identification of his ad, and in response present a set of information items relevant to his consideration for association with his ad. Such an ad may include information about a product, a brand, a retailer, a place, a location, an event, and so on. The advertising system may determine the set of information items based on such information. For instance, the advertising system may identify competing or otherwise related products, brands, retailers, places, and events based on other ads that are associated with the seller's ad or the information in or about the seller's ad, the other ads comprising information about the competing or related products, brands, places, retailers, and events. For example, seller A may have associated an ad with seller B or seller B's ads. When seller B indicates to the advertising system that it is interested in placing an ad with the system, the system may indicate to seller B that seller A or seller A's ads are a candidate for association with seller B's ad. In one embodiment, the advertising system may select the information items for association with the seller's ad without the seller's explicit selection of those information items. For instance, the system may select competing or complementary products, brands, or retailers for the seller's ad based on associations established by other users of the system, and the seller may provide criteria to assist the selection process, such as information on popularities and advertising costs associated with the candidate information items. In some embodiments, the system may also identify the intent of the consumer in relation to the selected information item of interest in consideration for whether to trigger the presentation of a seller's ad, the ad being associated with the selected information item. For example, the information item of interest may be about a product, and the consumer would be presented the ad if he indicates his interest in an online offer for the product, but not be presented the ad if his interest in in an online review of the product. The system identifies and maintains the context of the information items and corresponds the context to the intent of the consumer.

In another embodiment, another seller may also associate an information item with her ad, and indicate to the system the preferred position for her ad to appear in an ordered list of ads. When the preferred position of the other seller is the same as the preferred position of the seller, then the ad of whichever seller whose attains a better ranking in the system would have their ad promoted to a higher and unassigned position for free. For example, a better ranking may be determined based on the size of the advertising budget associated with an account. In one embodiment, how ads from competing sellers may be ordered or selected over others for presentation to the consumer may also be based on an attribute of the ads. For instance, a “price” attribute associated with an ad may be utilized for such comparison or determination, even when other attributes of the ads in question, such as “product”, are not semantically compatible. In another embodiment, the seller may submit a query of products or brands to the system, and receive from the system a list of sellers selling the products or brands. The seller may then choose which seller(s) on the list to associate his ad (e.g., of his own store) with, so that a consumer would be presented with the seller's ad when an interested information item relative to the consumer refers to the sellers so chosen. In another embodiment, the seller may submit location information to the system so to reveal local competitors or sellers for association with his ads. The seller may also simply submit or identify his ads to the system that would then derive based on the ads the relevant competitors or sellers for consideration of association with his ads. The system may also derive based on the ads the relevant products or brands for consideration of association with his ads.

In another embodiment, the more an information item in the system receives requests from sellers to associate their ads with, the more the costs associated with the information item would go up, but only after the current session (e.g., the current day, a preset number of accounts, a preset number of associations for a given time range and location) of association bidding or sales is over.

In another embodiment, the consumer may be watching a video or slide show delivered by the system, the video or slide show presenting a series or collection of information items chronologically. Ads associated with one of these information items may be presented to the consumer in connection with the presentation of that particular information item. Such ads may also be presented as interstitials during the video or among slideshow content. If the content of interest to the consumer is an online newspaper comprising a plurality of information items, ads associated with these information items may also be presented along with their individual information items to the consumer, even though the consumer might not have expressly identified or otherwise indicated that all these information items are of his interest. Alternatively, an ad associated with a particular information item among the plurality of information items may only be presented to the consumer when he selects the particular information item, while ads associated with the other information items therein are hidden. When the consumer selects another information item so presented, the ad associated with the previously selected information item would disappear from the presentation, and the ad associated with the newly selected one would appear.

The embodiments discussed herein are illustrative of the present invention. As these embodiments are described with reference to illustrations, various modifications or adaptations of the methods and/or specific structures described herein may become apparent to those skilled in the art. All such modifications, adaptations, or variations that rely upon the teachings of the present invention, and through which these teachings have advanced the art, are considered to be within the spirit and scope of the present invention. Hence, these descriptions and figures should not be considered in a limited sense, as it is understood that the present invention is in no way limited to only the embodiments illustrated.

While the present invention has been described in connection with the preferred aspects, as illustrated in the various figures, it is understood that other similar aspects may be used or modifications and additions may be made to the described aspects for performing the same function of the present disclosure without deviating there from. Therefore, the present disclosure should not be limited to any single aspect, but rather construed in breadth and scope in accordance with the appended claims. For example, the various procedures described herein may be implemented with hardware or software, or a combination of both. The invention may be implemented with computer-readable storage media and/or computer-readable communication media. Thus, the invention, or certain aspects or portions thereof, may take the form of program code (i.e., instructions) embodied in tangible media, such as floppy diskettes, CD-ROMs, hard drives, or any other machine-readable storage medium. Likewise, the invention, or certain aspects or portions thereof, may be embodied in propagated signals, or any other machine-readable communications medium. Where the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

What is claimed:

1. A method for advertising an information item, comprising:
presenting a first set of information items that may be associated with an advertisement to a first user, the first user being associated with an account, the first set of information items comprising a first information item, the first information item being related to a subject matter and having a cost information;
receiving from the first user an indication of selecting the first information item;
receiving an indication of a second information item from the first user, the second information item being associated with the account, the second information item comprising an advertisement to be associated with the first information item;
in response to receiving the indication of the second information item, and to receiving the indication of selecting the first information item, associating the first information item with the second information item;
determining a rate information for presenting the second information item with the first information item based on the first information item's cost information;
presenting a second set of information items to a second user, the second set of information items comprising a third information item, the second set of information items comprising content requested by the second user;
receiving an indication of selecting the third information item for the second user;
in response to determining that the third information item matches the first information item, and to associating the first information item with the second information item, presenting a response to the second user, the response comprising a representation or indication of at least a part of the second information item;
determining a charge for presenting the response based on the rate information; and
applying the charge to the first user's account.

2. The method of claim 1, further comprising:
receiving an indication of a query from the first user;
wherein presenting the first set of information items that may be associated with the advertisement to the first user comprises presenting in response to the query from the user the first set of information items to the first user;
receiving an indication of another query from the second user; and
wherein presenting the second set of information items to the second user comprises presenting in response to the other query the second set of information items to the second user; and
wherein receiving the indication of selecting the third information item for the second user comprises receiving the indication of selecting the third information item from the second user.

3. The method of claim 2, wherein the query from the first user comprises a query referring to product information, the product information including brand information, and further comprising:
determining one or more products or brands based at least in part on the product information;
determining one or more providers, each provider being associated with one of the one or more products or brands;
wherein the first set of information items comprises indications of providers, the indications each referring to one of the one or more providers; and
wherein determining that the third information item matches the first information item comprises determining that the third information refers to a provider being referred to by the first information item.

4. The method of claim 2, wherein the query from the first user includes a query referring to location information, and further comprising:
determining one or more providers based at least in part on the location information;
wherein the set of information items includes indications of providers, the indications each referring to any of the one or more providers; and
wherein determining that the third information item matches the first information item includes determining that the third information refers to a provider being referred to by the first information item.

5. The method of claim 2, further comprising:
wherein presenting to the first user the first set of information items comprises presenting to the first user the set of information items in descending order of relative popularity among the information items, and cost information associated with each of the information items;
receiving from the first user an indication of a position preference associated with the first information item;
associating the position preference with the second information item; and
wherein the response to the second user includes an indication of a list of information items, the list comprising the second information item in a position equal to or higher than the position preference.

6. The method of claim 5, further comprising:
presenting to the first user an indication of position information in response to receiving the indication of the first information item, the position information comprising a set of positions each being associated with a price; and
wherein the position preference associated with the first information item is among the set of positions.

7. The method of claim 5, further comprising:
presenting a third set of information items to a third user, the third user being associated with a second account;
receiving from the third user an indication of a fourth information item, the fourth information item being relative to the third set of information items;
receiving an indication of a fifth information item, the fifth information item being associated with the second account;
receiving from the third user an indication of a second position preference, the second position preference being associated with the fourth information item;
associating the second position preference with the fifth information item;
associating the forth information item with the fifth information item;
wherein determining that the third information item matches the first information item comprises determining that the third information item matches the first information item and the fourth information item;
wherein presenting the response to the second user comprises presenting a response to the second user, the response being based at least in part on a representation or indication of the second information item, or part thereof, and a representation or indication of the fifth information item, or part thereof;
determining that the position preference and the second position preference refer to the same position;
determining that the account, the account being associated with the first user has a higher ranking than the second account, the second account being associated with the third user;
wherein the response to the second user comprises an indication of a list of information items, the list comprising the second information item in a position equal to or higher than the position preference, and the fifth information item in another position equal to or higher than the other position preference, the position being higher than the second position;
determining a second rate information relative to the fifth information item being included in the response;
determining a second charge relative to the second rate information; and
applying the second charge to the third user's account.

8. The method of claim 6, wherein the position information comprises a plurality of sets of positions, each set being associated with location information or time information.

9. A computer system, comprising:
a processor; and
a memory coupled to the processor when the system is operational, the memory comprising processor-executable instructions, that upon execution by the processor, cause the computer system to at least:
present a first set of information items that may be associated with an advertisement to a first user, the first user being associated with an account, the first set of information items comprising a first information item, the first information item being related to a subject matter and having a cost information;
receive from the first user an indication of selecting the first information item;
receive an indication of a second information item from the first user, the second information item being associated with the account, the second information item comprising an advertisement to be associated with the first information item;
associate the first information item with the second information item;
determine a rate information for presenting the second information item with the first information item based on the first information item's cost information;
present a second set of information items to a second user, the second set of information items comprising a third information item, the second set of information items comprising content requested in relation to the second user;
receive an indication of selecting the third information item for the second user;
determine that the third information item matches the first information item;
present a response to the second user, the response comprising an indication of the second information item;
determine a charge for presenting the response based on the rate information; and
apply the charge to the first user's account.

10. The computer system of claim 9, wherein the instructions that upon execution by the processor cause the computer system to at least present the response to the second user, the response comprising an indication of the second information item, further cause the computer system to at least:
determine the first set of information items based at least in part on the second information item.

11. The computer system of claim 10, wherein:
the instructions that, upon execution by the processor, cause the computer system to at least determine the set of information items based at least in part on the second information item, further cause the computer system to at least determine one or more providers based at least in part on the second information item; and
the instructions that, upon execution by the processor, cause the computer system to at least determine that the third information item matches the first information item, further cause the computer system to at least determine that the third information refers to a provider being referred to by the first information item.

12. The computer system of claim 10, wherein:
the instructions that, upon execution by the processor, cause the computer system to at least determine the first set of information items based at least in part on the second information item, further cause the computer system to at least determine one or more products or brands based on the second information item; and
the instructions that, upon execution by the processor, cause the computer system to at least determine that the third information item matches the first information item, further cause the computer system to at least determine that the third information refers to a product or brand being referred to by the first information item.

13. The computer system of claim 9, wherein the instructions that, upon execution by the processor, cause the computer system to at least present the response to the second user, the response comprising an indication of the second information item, further cause the computer system to at least:
receive one or more requests to associate one or more information items with a fourth information item, the one or more requests having come from users not related to the first user's account;
associate the one or more information items with the fourth information item, and the one or more information items with an account other than the first user's account; and
wherein the instructions that, upon execution by the processor, cause the computer system to at least determine the set of information items based at least in part on the second information item, further cause the computer system to at least determine the set of information items based on the one or more information items.

14. The computer system of claim 9, wherein the instructions that, upon execution by the processor, cause the computer system to at least determine that the third information item matches the first information item, further cause the computer system to at least determine that the third information item indicates sales of the first information item.

15. The computer system of claim 9, wherein the first information item comprises a plurality of information items; and
the instructions that, upon execution by the processor, cause the computer system to at least determine that the third information item matches the first information item, further cause the computer system to at least determine that the third information item matches one of the plurality of information items.

16. The computer system of claim 9, wherein the instructions that, upon execution by the processor, cause the computer system to at least present the response to the second user, the response comprising an indication of the second information item, further cause the computer system to at least:
associate a session with the first information item's cost information, the session including a limit, wherein the limit includes a time period, a preset number of user accounts, or a preset number of associations for a location;
determine an adjustment based at least in part on a number of associations that the first information item has with other information items, the other information items including the second information item;
associate the adjustment with the cost information; and
update the cost information based on the adjustment, after expiry of the session.

17. The computer system of claim 9, wherein the instructions that, upon execution by the processor, cause the computer system to at least present the response to the second user, the response comprising an indication of the second information item, further cause the computer system to at least:
present to the second user a series of information items chronologically;
wherein the instructions that, upon execution by the processor, cause the computer system to at least receive the indication of selecting the third information item for the second user, further cause the computer system to at least present the third information item to the second user, the third information item being comprised by the series of information items; and
wherein the response comprises the third information item and an indication of the second information item.

18. The computer system of claim 9, wherein the instructions that, upon execution by the processor, cause the computer system to at least present the response to the second user, the response comprising an indication of the second information item, further cause the computer system to at least:
present the indication of the second information before or after presenting the third information item to the second user.

19. The computer system of claim 9, wherein the instructions that, upon execution by the processor, cause the computer system to at least present the response to the second user, the response comprising an indication of the second information item, further cause the computer system to at least:
present to the second user a collection of information items spatially;
wherein the instructions that, upon execution by the processor, cause the computer system to at least receive the indication of selecting the third information item for the second user, further cause the computer system to at least receive from the second user a request for the collection of information items, the collection of information items having the third information item; and
wherein the response comprises the third information item and an indication of the second information item, the indication of the second information item being closer to the third information item than to other information items in the collection of information items.

20. The computer system of claim 9, wherein the instructions that, upon execution by the processor, cause the computer system to at least present the response to the second user, the response comprising an indication of the second information item, further cause the computer system to at least:
receive an indication of a fourth information item;
receive an indication of a fifth information item, the fifth information item being associated with another account;
associate the fourth information item with the fifth information item;
wherein the second set of information items comprises a collection of information items spatially, the collection of information items having an indication of the first information item and an indication of the fourth information item, without having an indication of the second information item and an indication of the fifth information item;
wherein the instructions that, upon execution by the processor cause the computer system to at least receive the indication of selecting the third information item for the second user, further cause the computer system to at least receive from the second user a request relative to the third information item, the request including a command to reveal more of the third information item; and
wherein the response comprises the first information item, or part thereof, and an indication of the second information item.
